(19) United States
(12) Patent Application Publication
(10) Pub. No.: US 2026/0185657 A1
(43) Pub. Date: Jul. 2, 2026

(54) ELECTRIC-POWERED LUBRICANT DISPENSER, AND METHOD FOR DISPENSING LUBRICANT FROM ELECTRIC-POWERED LUBRICANT DISPENSER

(71) Applicant: MAKITA CORPORATION, Anjo-shi (JP)

(72) Inventors: Yuki HAYASHI, Anjo-shi (JP); Hidefumi HAGIWARA, Anjo-shi (JP)

(73) Assignee: MAKITA CORPORATION, Anjo-shi (JP)

(21) Appl. No.: 19/431,447

(22) Filed: Dec. 23, 2025

(30) Foreign Application Priority Data
Dec. 27, 2024 (JP) 2024-233017

(51) Int. Cl. F16N 5/00; F16N 7/38; F16N 27/00

(52) U.S. Cl. CPC F16N 5/00; F16N 7/38; F16N 27/00; F16N 2270/00

(57) ABSTRACT

One aspect of the present disclosure provides an electric-powered lubricant dispenser including a motor, a pump, a drive circuit, and control circuit. The pump is (i) driven by the motor and (ii) dispenses a lubricant. The drive circuit drives the motor. The control circuit rotates the motor via the drive circuit. The control circuit performs a specified process based on (i) the motor being driven and (ii) an actual operating amount of the motor satisfying a specified requirement. The actual operating amount indicates an actual rotational speed of the motor or a magnitude of fluctuation in the actual rotational speed. The specified requirement is a requirement indicating that gas is present in the pump.

### CROSS-REFERENCE TO RELATED APPLICATIONS

The present application claims the benefit of Japanese Patent Application No. 2024-233017 filed on December 27, 2024 with the Japan Patent Office, the entire disclosure of which is incorporated herein by reference.

### BACKGROUND

The present disclosure relates to an electric-powered lubricant dispenser.

Japanese Unexamined Patent Application Publication No. 2024-134818 discloses a grease dispenser equipped with a pump. In this grease dispenser, the pump receives grease from a tank and dispenses the grease.

### SUMMARY

In the grease dispenser, air may become trapped inside the pump. Air trapped inside the pump may interfere with proper dispensing of grease by the pump. For example, an amount of grease dispensed may temporarily decrease or grease may temporarily cease to be dispensed.

In one aspect of the present disclosure, it is desirable that presence of gas in a pump can be appropriately detected.

One aspect of the present disclosure provides an electric-powered lubricant dispenser including a motor, a pump, a drive circuit, and a control circuit.

The pump is driven by the motor. The pump dispenses a lubricant. The drive circuit drives the motor.

The control circuit rotates the motor via the drive circuit.

The control circuit performs a specified process based on (i) the motor being driven and (ii) an actual operating amount of the motor satisfying a specified requirement. The actual operating amount indicates an actual rotational speed of the motor or a magnitude of fluctuation in the actual rotational speed. The specified requirement is a condition indicating that gas is present in the pump. The specified requirement may also be a condition indicating that gas may be present in the pump. That is, the actual operating amount satisfying the specified requirement may mean that gas is (or may be) present in the pump.

The electric-powered lubricant dispenser configured as such can appropriately detect the presence of gas in the pump.

Another aspect of the present disclosure is a method for dispensing a lubricant from an electric-powered lubricant dispenser, the method including: driving a pump of the electric-powered lubricant dispenser by a motor of the electric-powered lubricant dispenser, the pump being configured to dispense the lubricant; and performing a specified process in the electric-powered lubricant dispenser based on an actual operating amount of the motor satisfying a specified requirement during driving of the motor, the actual operating amount of the motor indicating an actual rotational speed of the motor or a magnitude of fluctuation in the actual rotational speed, the specified requirement being a requirement indicating that gas is present in the pump.

With the method as above, it is possible to appropriately detect that the gas is present in the pump in the electric-powered lubricant dispenser.

### BRIEF DESCRIPTION OF THE DRAWINGS

An example embodiment of the present disclosure will be described hereinafter with reference to the accompanying drawings, in which:

FIG. 1 is a perspective view of an electric-powered lubricant dispenser in a first embodiment;

FIG. 2 is a central longitudinal sectional view of the electric-powered lubricant dispenser;

FIG. 3 is an explanatory diagram illustrating a mechanism by which a plunger moves up and down due to rotation of a motor;

FIG. 4 is a plan view of an operation panel of the electric-powered lubricant dispenser;

FIG. 5 is a circuit diagram showing an electrical configuration of the electric-powered lubricant dispenser;

FIG. 6 is a function block diagram of a control circuit in the electric-powered lubricant dispenser;

FIG. 7 is an explanatory diagram showing an example operation of the motor when the pump is in a normal state and the motor is rotating at low to medium speeds;

FIG. 8 is an explanatory diagram showing an example operation of the motor when the pump is in the normal state and the motor is rotating at high speeds;

FIG. 9 is an explanatory diagram showing an example operation of the motor when air is trapped in the pump and the motor is rotating at high speeds;

FIG. 10 is an explanatory diagram showing an example setting of a first threshold;

FIG. 11 is a flowchart of a main process;

FIG. 12 is a flowchart of a stoppage process;

FIG. 13 is a flowchart of an in-operation process;

FIG. 14 is a flowchart of an air entrapment detection process of a first embodiment;

FIG. 15 is a flowchart of a duration determination process;

FIG. 16 is a flowchart of the air entrapment detection process of a second embodiment; and

FIG. 17 is a flowchart of the air entrapment detection process of a third embodiment.

### DETAILED DESCRIPTION OF EXEMPLARY EMBODIMENTS

### 1. Overview of Embodiments

In the present disclosure, terms such as “first”, “second”, and the like only intend to distinguish one element from another, and do not intend to limit the order or the number of the elements. Accordingly, a first element may be referred to as a second element, and similarly, a second element may be referred to as a first element. Additionally, a first element may be included without a second element, and similarly, a second element may be included without a first element.

One embodiment may provide an electric-powered lubricant dispenser (or a handheld electric-powered lubrication dispenser, or an electric-powered lubricant supply device) including at least any one of:
Feature 1: a motor;
Feature 2: a pump;
Feature 3: the pump is configured to be driven by the motor;
Feature 4: the pump is configured to dispense a lubricant;
Feature 5: a drive circuit;
Feature 6: the drive circuit is configured to drive the motor;
Feature 7: a control circuit;
Feature 8: the control circuit is configured to rotate the motor via the drive circuit, wherein the control circuit may be configured to control the drive circuit to thereby rotate the motor;
Feature 9: the control circuit is configured to perform a specified process based on (i) the motor being driven and (ii) an actual operating amount of the motor satisfying a specified requirement;
Feature 10: the actual operating amount indicates an actual rotational speed of the motor or a magnitude of fluctuation in the actual rotational speed, wherein the actual rotational speed may be defined as a scalar quantity where a rotational direction is not considered; and
Feature 11: the specified requirement is a condition (or index) indicating (or specifying) that gas (or bubbles) is present in the pump; in other words, the specified requirement is a requirement for the actual operating amount corresponding to a state where the gas is present in the pump, wherein the specified requirement may be satisfied in response to the gas being present in the pump (that is, the gas is mixed into the lubricant), or wherein the specified requirement may be satisfied in response to a specified volume or more of the gas being present in the pump.

The electric-powered lubricant dispenser including at least Features 1 through 11 can appropriately detect that the gas is present in the pump.

The motor is in the form of an electric motor. The motor may be configured to generate a driving force (or a rotational driving force, or a driving torque, or a rotational force, or a torque). The pump may be configured (i) to directly or indirectly receive the driving force from the motor, and (ii) to be driven by the driving force. Examples of the motor include a DC motor, an AC motor, and a stepping motor. Examples of the DC motor include a brushless motor (or a brushless DC motor) and a brushed DC motor.

Examples of the lubricant include a liquid lubricant and a semi-solid lubricant. Examples of the liquid lubricant include lubricating oil. Examples of the semi-solid lubricant include grease. That is, examples of the electric-powered lubricant dispenser include an electric grease gun.

The pump may be configured (i) to receive the lubricant, and (ii) to dispense the received lubricant. The lubricant may be introduced into (i.e., received within) the pump by receiving a pressure from outside the pump. Alternatively, the pump may be configured to generate a negative pressure within the pump and to use the negative pressure to receive (i.e., suck in) the lubricant.

The pump may include any form of pump. Examples of the pump include a positive displacement pump. Examples of the positive displacement pump include a reciprocating pump and a rotary pump. Examples of the reciprocating pump include a plunger pump configured so that a plunger reciprocates, and a diaphragm pump configured so that a diaphragm reciprocates. Examples of the pump may also include a non-positive displacement pump.

The drive circuit may include multiple switch elements electrically coupled to the motor. Examples of the drive circuit include a full-bridge circuit and a half-bridge circuit.

The full-bridge circuit may be electrically coupled to the motor. In this case, the motor may be in the form of a three-phase motor (for example, the brushless motor). The motor may (i) have three terminals, and (ii) be configured to receive electric power from the full-bridge circuit (that is, the drive circuit) via the three terminals to thereby rotate.

The full-bridge circuit may include six switch elements. Examples of each of the six switch elements include a semiconductor switch and a mechanical relay. Examples of the semiconductor switch include a field-effect transistor (FET), a bipolar transistor, an insulated gate bipolar transistor (IGBT), a thyristor, and a solid-state relay (SSR).

The six switch elements may include three high-side switches and three low-side switches. The three high-side switches may be electrically coupled to a positive electrode of a power source (for example, a DC power source) and the three terminals of the motor. The three low-side switches may be electrically coupled to a negative electrode of the power source and the three terminals of the motor. Each of the three high-side switches may be (i) disposed on a corresponding one of the three positive-side current paths and (ii) configured to complete or interrupt the positive-side current path. Each of the three positive-side current paths electrically couple a corresponding one of the three terminals of the motor to the positive electrode of the power source. Each of the three low-side switches may be (i) disposed on a corresponding one of the three negative-side current paths and (ii) configured to complete or interrupt the three negative-side current paths. Each of the three negative-side current paths electrically couple a corresponding one of the three terminals of the motor to the negative electrode of the power source.

The specified requirement may indicate that the gas may be present in the pump. That is, the actual operating amount satisfying the specified requirement may mean that either the gas is actually present in the pump or the gas may be present in the pump.

The gas being present in the pump may include cases in which (i) the gas is mixed into the lubricant in the pump and/or (ii) the gas is present in a container (e.g., chamber described later) inside the pump in which the lubricant is stored.

The specified process may be any process in response to the gas being present in the pump. The specified process may be a process that should be performed or is preferably performed when the gas is present in the pump. When the gas is present in the pump, the lubricant may not be dispensed normally. Specifically, an amount of the lubricant dispensed may decrease or the lubricant may cease to be dispensed. Therefore, the specified process may also be a process in response to a state where the lubricant may not be dispensed normally, that is, a process that should be performed or is preferably performed in such state. Examples of the specified process are described later.

In one embodiment, the control circuit may be integrated into a single electronic unit, a single electronic device, or a single circuit board.

In one embodiment, the control circuit may be a combination of two or more electronic circuits, two or more electronic units, or two or more electronic devices provided separately on or in the electric-powered lubricant dispenser.

In one embodiment, the control circuit may include a microcomputer (or a microcontroller or a microprocessor), a wired logic, an application-specific integrated circuit (ASIC), an application specific standard product (ASSP), a programmable logic device (PLD) (e.g., field-programmable gate array (FPGA)), a discrete electronic component, and/or combinations thereof.

In one embodiment, the electric-powered lubricant dispenser may be handheld (in other words, portable). That is, the electric-powered lubricant dispenser may include a grip designed to be grasped by a user of the electric-powered lubricant dispenser. The electric-powered lubricant dispenser may be used while the grip is grasped by the user.

One embodiment may include, in addition to or in place of at least any one of the above Features 1 through 11, at least any one of:
Feature 12: the actual operating amount includes an amplitude of the actual rotational speed; and
Feature 13: the specified requirement includes a maximum value of the amplitude within a specified drive period being less than or equal to a first threshold.

The electric-powered lubricant dispenser including at least Features 1 through 13 can accurately detect that the gas is present in the pump.

Feature 13 may be rephrased as the specified requirement being satisfied in response to the maximum value of the amplitude within the specified drive period being less than or equal to the first threshold. The first threshold may be smaller than a range of the amplitude (e.g., its minimum value) that can be generated in a normal state. The first threshold may be greater than a range of the amplitude (e.g., its maximum value) that can be generated in an abnormal state. The normal state corresponds to a state where no gas is present in the pump. The abnormal state corresponds to a state where gas is present in the pump. The amplitude of the actual rotational speed may be defined as a difference between a local maximum (or local maximal value) and a local minimum (or local minimum value) of the actual rotational speed, which changes over time. The maximum value of the amplitude is a difference between the maximum and minimum values of the actual rotational speed within the specified drive period.

The specified drive period is a specified period during which the motor is driven. If the pump is configured to repeat a specified operation, the specified drive period may at least include a period during which the specified operation is performed.

One embodiment may include, in addition to or in place of at least any one of the above Features 1 through 13, at least any one of:
Feature 14: the actual operating amount includes an absolute value of a derivative value of the actual rotational speed; and
Feature 15: the specified requirement includes a maximum value of the absolute value within the specified drive period being less than or equal to a second threshold.

The electric-powered lubricant dispenser including at least Features 1 through 11, 14 and 15 can accurately detect that the gas is present in the pump.

Feature 15 may be rephrased as the specified requirement being satisfied when the maximum value of the absolute value within the specified drive period is less than or equal to the second threshold. The specified requirement may also be rephrased as an absolute value of the derivative value of the actual rotational speed not exceeding the second threshold throughout the specified drive period.

The second threshold may be smaller than a range of the absolute value (e.g., its minimum value) that can be generated in the normal state. The second threshold may be larger than a range of the absolute value (e.g., its maximum value) that can be generated in the abnormal state.

The derivative value of the actual rotational speed may be calculated in any manner. The derivative value may be calculated, for example, based on time derivative. That is, an amount of change in the actual rotational speed per specified unit time may be calculated as the derivative value. Alternatively, the derivative value may be calculated based on rotational angle derivative. That is, the amount of change in the actual rotational speed during the time the motor rotates by a specified unit rotational angle may be calculated as the derivative value.

One embodiment may include, in addition to or in place of at least any one of the above Features 1 through 15, at least any one of:
Feature 16: the actual operating amount includes the actual rotational speed; and
Feature 17: the specified requirement includes the minimum value of the actual rotational speed within the specified drive period being greater than or equal to a third threshold.

The electric-powered lubricant dispenser including at least Features 1 through 11, 16 and 17 can accurately detect that the gas is present in the pump.

Feature 17 may be rephrased as the specified requirement being satisfied when the minimum value of the actual rotational speed within the specified drive period is greater than or equal to the third threshold. The specified requirement may also be rephrased as the actual rotational speed not falling below the third threshold throughout the specified drive period. The third threshold may be greater than a range of the actual rotational speed (e.g., its maximum value) that can be generated in the normal state. The third threshold may be smaller than a range of the actual rotational speed (e.g., its minimum value) that can be generated in the abnormal state.

One embodiment may include, in addition to or in place of at least any one of the above Features 1 through 17,
Feature 18: the control circuit is configured to change the first threshold in accordance with the operating state of the electric-powered lubricant dispenser.

The electric-powered lubricant dispenser including at least Features 1 through 13 and 18 can accurately detect that the gas is present in the pump.

The operating state may include any state that affects the actual rotational speed. In other words, the operating state may include any state in which the actual rotational speed can change in response to a change in the operating state.

One embodiment may include, in addition to or in place of at least any one of the above Features 1 through 18,
Feature 19: the control circuit is configured to change the second threshold in accordance with the operating state of the electric-powered lubricant dispenser.

The electric-powered lubricant dispenser including at least Features 1 through 11, 14, 15 and 19 can accurately detect that the gas is present in the pump.

One embodiment may include, in addition to or in place of at least any one of the above Features 1 through 19,
Feature 20: the control circuit is configured to change the third threshold in accordance with the operating state of the electric-powered lubricant dispenser.

The electric-powered lubricant dispenser including at least Features 1 through 11, 16, 17 and 20 can accurately detect that the gas is present in the pump.

One embodiment may include, in addition to or in place of at least any one of the above Features 1 through 20, at least any one of:
Feature 21: the control circuit is configured to set a desired rotational speed (or target rotational speed), the desired rotational speed being a desired (or target) value for the rotational speed of the motor;
Feature 22: the control circuit is configured to control the drive circuit such that the actual rotational speed is consistent with the desired rotational speed (i.e., the set desired rotational speed).
Feature 23: the operating state includes the desired rotational speed.

The electric-powered lubricant dispenser including at least Features 1 through 13, 18, and 21 through 23, and the electric-powered lubricant dispenser including at least Features 1 through 11, 14, 15, 19 and 21 through 23, can accurately detect that the gas is present in the pump.

One embodiment may include, in addition to or in place of at least any one of the above Features 1 through 23,
Feature 24: the control circuit is configured to set the third threshold to a value less than the desired rotational speed.

The electric-powered lubricant dispenser including at least Features 1 through 11, 16, 17 and 20 through 24 can accurately detect that the gas is present in the pump.

One embodiment may include, in addition to or in place of at least any one of the above Features 1 through 24, at least any one of:
Feature 25: the control circuit is configured to output a pulse width modulation signal to the drive circuit to control the drive circuit, and the pulse width modulation signal has a duty ratio;
Feature 26: the drive circuit is configured (i) to receive the pulse width modulation signal, and (ii) to drive the motor in accordance with the duty ratio of the received pulse width modulation signal; and
Feature 27: the operating state includes the duty ratio.

The electric-powered lubricant dispenser including at least Features 1 through 13, 18, and 25 through 27, the electric-powered lubricant dispenser including at least Features 1 through 11, 14, 15, 19, and 25 through 27, and the electric-powered lubricant dispenser including at least Features 1 through 11, 16, 17, 20, and 25 through 27 can accurately detect that the gas is present in the pump.

The drive circuit may be configured to supply electric power in accordance with the duty ratio to the motor to drive the motor. Specifically, the drive circuit may be configured to increase the electric power as the duty ratio increases. The duty ratio may increase as the desired rotational speed increases.

When the drive circuit includes multiple switch elements, at least one of the multiple switch elements may be configured (i) to receive the pulse width modulation signal and (ii) to be turned on or off (thereby completing or interrupting the corresponding current path) in accordance with the duty ratio of the pulse width modulation signal. That is, the larger the duty ratio, the longer the period during which the multiple switch elements are turned on (that is, the corresponding current path is completed), thereby increasing electric power supplied to the motor (and consequently an output of the motor and/or the actual rotational speed).

One embodiment may include, in addition to or in place of at least any one of the above Features 1 through 27,
Feature 28: the operating state includes the actual rotational speed of the motor.

The electric-powered lubricant dispenser including at least Features 1 through 13, 18, and 28, the electric-powered lubricant dispenser including at least Features 1 through 11, 14, 15, 19, and 28, and the electric-powered lubricant dispenser including at least Features 1 through 11, 16, 17, 20, and 28 can accurately detect that the gas is present in the pump.

The control circuit may set a target threshold (i.e., the first threshold, the second threshold, and/or the third threshold) in any manner in accordance with the operating state. The control circuit may set the threshold in accordance with a pre-prepared function that uses the operating state as a variable. The control circuit may set the threshold by referring to a pre-prepared table or similar database. In the table, the operating state and the threshold are mutually associated.

The control circuit may increase the first threshold and/or the second threshold as the desired rotational speed increases. In this case, in a region where the desired rotational speed is greater than or equal to a specified magnitude, the control circuit may decrease the first threshold and/or the second threshold as the desired rotational speed increases.

Similarly, the control circuit may increase the first threshold and/or the second threshold as the duty ratio increases. In this case, in a region where the duty ratio is greater than or equal to a specified magnitude, the control circuit may decrease the first threshold and/or the second threshold as the duty ratio increases.

The control circuit may set the third threshold such that a difference between the desired rotational speed and the third threshold becomes smaller as the desired rotational speed increases. Similarly, the control circuit may set the third threshold such that a difference between the desired rotational speed corresponding to the duty ratio and the third threshold becomes smaller as the duty ratio increases.

One embodiment may include, in addition to or in place of at least any one of the above Features 1 through 28, at least any one of:
Feature 29: the control circuit is configured to acquire a temperature of the electric-powered lubricant dispenser; and
Feature 30: the operating state includes the temperature.

The electric-powered lubricant dispenser including at least Features 1 through 13, 18, 29, and 30, the electric-powered lubricant dispenser including at least Features 1 through 11, 14, 15, 19, 29, and 30, and the electric-powered lubricant dispenser including at least Features 1 through 11, 16, 17, 20, 29, and 30 can accurately detect that the gas is present in the pump.

The control circuit may acquire the temperature of any portion of the electric-powered lubricant dispenser. The temperature may be a temperature of the lubricant or a temperature that can be regarded as a temperature (or change in temperature) of the lubricant.

In one embodiment, the electric-powered lubricant dispenser may include a temperature detector configured and positioned to detect the temperature of the lubricant directly or indirectly. The control circuit may change the first threshold, the second threshold, and/or the third threshold in response to the temperature detected by the temperature detector. The temperature detector may be in direct contact with the lubricant. In this case, the temperature detector can directly detect the temperature of the lubricant. Alternatively, the temperature detector may be apart from the lubricant. The temperature detector may be in any form capable of detecting the temperature. Examples of the temperature detector include a positive temperature coefficient (PTC) thermistor, a negative temperature coefficient (NTC) thermistor, and a critical temperature resistor (CTR) thermistor.

When an embodiment includes the above Feature 29, the embodiment may further include at least one of:
Feature 31: the control circuit is configured to decrease the first threshold as the acquired temperature increases;
Feature 32: the control circuit is configured to decrease the second threshold as the acquired temperature increases; and
Feature 33: the control circuit is configured to increase the third threshold as the acquired temperature increases.

The electric-powered lubricant dispenser including at least Features 1 through 13, 18, and 29 through 31, the electric-powered lubricant dispenser including at least Features 1 through 11, 14, 15, 19, 29, 30, and 32, and the electric-powered lubricant dispenser including at least Features 1 through 11, 16, 17, 20, 29, 30, and 33 can accurately detect that the gas is present in the pump.

The operating state may also include elements other than the desired rotational speed, the duty ratio, the actual rotational speed, and the temperature. Examples of the operating state include a magnitude of a voltage applied from the drive circuit to the motor, or a physical quantity indirectly indicating the magnitude of the voltage. If the drive circuit is configured to apply a voltage of a power source (e.g., a battery) to the motor, the operating state may include the voltage of the battery. In this case, as the battery voltage decreases, the voltage applied to the motor also decreases. Therefore, the first threshold may be set to decrease as the battery voltage decreases. The same applies to the second threshold and the third threshold. One embodiment may include a voltage detector configured to detect the voltage of the battery. The voltage detector may be configured (i) to receive the voltage of the battery and (ii) to output a voltage detection signal corresponding to a magnitude of the voltage to the control circuit. The control circuit may (i) obtain the magnitude of the voltage of the battery based on the voltage detection signal from the voltage detector and (ii) set the first threshold (or the second threshold or the third threshold) based on the obtained magnitude.

One embodiment may include, in addition to or in place of at least any one of the above Features 1 through 33, at least any one of:
Feature 34: a notifier;
Feature 35: the notifier is configured to notify the user that the gas is present in the pump; and
Feature 36: the specified process includes notifying the user of the information via the notifier.

In the electric-powered lubricant dispenser including at least Features 1 through 11, and 34 through 36, the user of the electric-powered lubricant dispenser can easily understand that the gas is present (or may be present) in the pump. The notifier may notify the user of the information by any method. The notifier may, for example, be configured to visually display the information. The notifier may, for example, be configured to output the information by sound or voice.

One embodiment may include, in addition to or in place of at least any one of the above Features 1 through 36, at least any one of:
Feature 37 :the pump is configured to repeat a specified dispensing operation for dispensing the lubricant;
Feature 38: the control circuit is configured to accumulate (i.e., cumulatively add) an actual dispensing count each time the pump performs the specified dispensing operation while the motor is driven, the actual dispensing count being a number of times the specified dispensing operation has been performed;
Feature 39: the control circuit is configured to stop the motor based on the actual dispensing count having reached a desired dispensing count, and
Feature 40: the specified process includes temporarily stopping accumulation of the actual dispensing count.

The electric-powered lubricant dispenser including at least Features 1 through 11 and 37 through 40 can inhibit or stop an actual dispensed amount of the lubricant, until the motor is stopped, from becoming less than a predefined amount corresponding to the desired dispensing count. The specified dispensing operation may include receiving the lubricant and dispensing the received lubricant.

One embodiment may include, in addition to or in place of at least any one of the above Features 1 through 40,
Feature 41: the control circuit is configured to resume the accumulation of the actual dispensing count after temporarily stopping the accumulation, based on the actual operating amount no longer satisfying the specified requirement.

The electric-powered lubricant dispenser including at least Features 1 through 11 and 37 through 41 can accurately dispense an amount of the lubricant corresponding to the desired dispensing count even if the gas is temporarily present in the pump during driving of the motor.

One embodiment may include, in addition to or in place of at least any one of the above Features 1 through 41, at least any one of:
Feature 42: the pump includes a chamber configured to contain the lubricant, wherein the chamber may be configured to contain the lubricant received within the pump;
Feature 43: the pump includes a dispensing port communicating with the chamber;
Feature 44: the pump includes a plunger; and
Feature 45: the plunger is located in the chamber, the plunger being configured (i) to reciprocate within the chamber based on a rotational force of the motor and (ii) to thereby dispense the lubricant in the chamber from the dispensing port, wherein the plunger may be reciprocated by the motor (or by a driving force of the motor).

The electric-powered lubricant dispenser including at least Features 1 through 11 and 42 through 45 can accurately detect that the gas is present in a reciprocating plunger pump.

The “gas being present in the pump” may include the gas being present in the chamber. The electric-powered lubricant dispenser may include a converter that converts rotational motion into linear motion. The converter is (i) directly or indirectly coupled to the motor and the reciprocating member, (ii) receives rotation from the motor, and (iii) converts that rotation into reciprocating motion of the reciprocating member. The converter may be one of multiple components that make up the pump.

One embodiment may include, in addition to or in place of at least any one of the above Features 1 through 45,
Feature 46: the specified drive period includes a period during which the plunger completes one reciprocation within the chamber.

The electric-powered lubricant dispenser including at least Features 1 through 13 and 42 through 46 can appropriately and efficiently detect that the gas is present in the reciprocating plunger pump.

The gas being present in the pump may include cases in which (i) the gas is present in the chamber, and/or (ii) the gas is mixed into a material in the chamber that is about to be dispensed by the plunger.

One embodiment may include, in addition to or in place of at least any one of the above Features 1 through 46,
Feature 47: the specified dispensing operation includes the plunger completing one reciprocation within the chamber.

The electric-powered lubricant dispenser including at least Features 1 through 11, 37 through 40, 42 through 45 and 47 can appropriately dispense an amount of the lubricant corresponding to the desired dispensing count.

One embodiment may include, in addition to or in place of at least any one of the above Features 1 through 47,
Feature 48: the control circuit is configured to stop the motor based on a state in which the actual operating amount satisfies the specified requirement continuing for a specified time during driving of the motor.

The electric-powered lubricant dispenser including at least Features 1 through 11 and 48 allows the user to take appropriate action when the state in which the gas is (or may be) present persists.

In one embodiment, the motor may be stopped without waiting for the specified time to elapse, in response to the specified requirement being satisfied.

One embodiment may include, in addition to or in place of at least any one of the above Features 1 through 48,
Feature 49: the control circuit is configured to detect, during driving of the motor, that the gas is (or may be) present in the pump, and/or that the pump is (or may be) attempting to dispense the gas, in response to the specified requirement being satisfied.

The electric-powered lubricant dispenser including at least Features 1 through 11 and 49 enables various actions to be taken in response to detection of the presence of gas.

One embodiment may include, in addition to or in place of at least any one of the above Features 1 through 49,
Feature 50: the lubricant is in a semi-solid form.

The electric-powered lubricant dispenser including at least Features 1 through 11 and 50 can appropriately detect whether the gas is mixed into the lubricant in the semi-solid form.

One embodiment may include, in addition to or in place of at least any one of the above Features 1 through 50,
Feature 51: the lubricant includes grease.

If the gas is mixed into the grease, the electric-powered lubricant dispenser including at least Features 1 through 11, and 51 can appropriately detect this.

One embodiment may provide a method for dispensing a lubricant from an electric-powered lubricant dispenser, the method including at least one of:
Feature 52: driving the pump of the electric-powered lubricant dispenser configured to dispense the lubricant by a motor of the electric-powered lubricant dispenser;
Feature 53: performing a specified process in the electric-powered lubricant dispenser based on an actual operating amount of the motor satisfying a specified requirement during driving of the motor;
Feature 54: the actual operating amount indicates the actual rotational speed of the motor or a magnitude of fluctuation in the actual rotational speed; and
Feature 55: the specified requirement indicates that the gas is present in the pump.

According to the method including at least Features 52 through 55, it is possible to appropriately detect that the gas is present in the pump.

In one embodiment, the above Features 1 through 55 may be combined in any combinations.

In one embodiment, any of the above Features 1 through 55 may be excluded.

### 2. Specific Example Embodiments

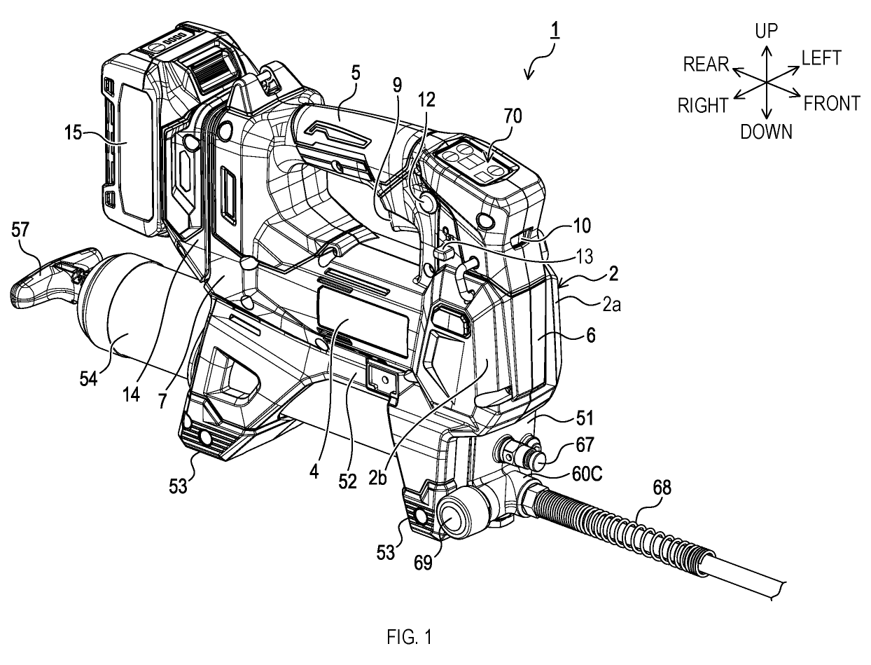

The following example embodiments provide an electric-powered lubricant dispenser 1 shown in FIG. 1. The electric-powered lubricant dispenser 1 is configured to dispense a lubricant. Specifically, the electric-powered lubricant dispenser 1 of the present embodiment is an electric-powered grease gun configured to dispense grease.

For convenience of explanation, directions in the electric-powered lubricant dispenser 1 are defined as shown appropriately in FIG. 1 and subsequent figures. Specifically, “up” (upward direction), “down” (downward direction), “right” (rightward direction), “left” (leftward direction), ‘front’ (forward direction), and “rear” (rearward direction) are defined. These directions are used solely to facilitate understanding of the structure of the electric-powered lubricant dispenser 1 and are not intended to limit the orientation of the electric-powered lubricant dispenser 1. The electric-powered lubricant dispenser 1 can be oriented in any direction.

### 2-1. First Embodiment

### 2-1-1. Mechanical Configuration of Electric-Powered Lubricant Dispenser

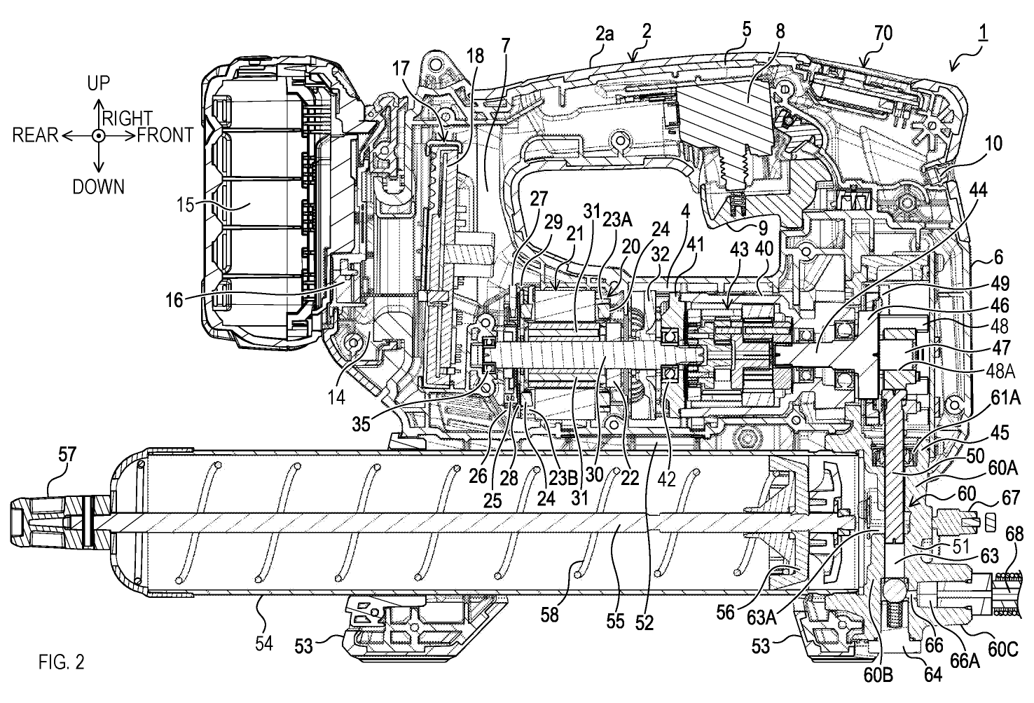

As shown in FIGS. 1 and 2, the electric-powered lubricant dispenser 1 of the first embodiment includes a housing 2. The housing 2 includes a first half housing 2a and a second half housing 2b joined together.

The housing 2 includes a motor container 4 at a central portion in its height direction. The height direction corresponds to a direction from bottom to top or from top to bottom of the housing 2. In the first embodiment, the motor container 4 has a cylindrical shape and extends in a length direction. The length direction corresponds to a direction from front to rear or from rear to front of the housing 2. The motor container 4 houses a motor 20. The motor 20 is an electric motor.

The housing 2 includes a grip 5 on its top. In the first embodiment, the grip 5 extends in the length direction and is bent downward. The motor container 4 includes a front joint portion 6 at its front end. The front joint portion 6 is joined to a front end of the grip 5. The motor container 4 includes a rear joint portion 7 at its rear end. The rear joint portion 7 is joined to a rear end of the grip 5. In the first embodiment, the rear joint portion 7 stands upward so as to form a space between the motor container 4 and the grip 5.

The electric-powered lubricant dispenser 1 includes a trigger switch 8 disposed in the grip 5. The electric-powered lubricant dispenser 1 includes a trigger 9 for a user of the electric-powered lubricant dispenser 1 to manually operate the trigger switch 8.

The trigger 9 is pulled by the user to drive the motor 20 (that is, to dispense grease). The trigger 9 is configured to be movable between an initial position and a maximum position. When the trigger 9 is not manually operated, the trigger 9 remains in the initial position. The trigger 9 moves from the initial position toward the maximum position as the trigger 9 is manually operated.

When the trigger 9 is positioned between the initial position and a minimum position, the trigger switch 8 is off, and the motor 20 is stopped. The minimum position is located between the initial position and the maximum position. When the trigger 9 is positioned between the minimum position and the maximum position, the trigger switch 8 is on, and the motor 20 can rotate. In the first embodiment, the trigger 9 protrudes downward from the grip 5.

The grip 5 includes a light 10 at its front. In the first embodiment, the light 10 includes a not shown light emitting diode (LED) as a light source.

The grip 5 includes an operation panel 70 on its front upper surface. The operation panel 70 is configured to be manually operated by the user to turn on or off the light 10 and to change settings of the electric-powered lubricant dispenser 1.

The grip 5 includes a first lock button 12 at the front of the trigger 9. The first lock button 12 is configured to be depressed by the user to lock the trigger 9 in the maximum position. The grip 5 includes a second lock button 13 below the first lock button 12. The second lock button 13 is configured to be depressed by the user to lock the trigger 9 in the initial position (that is, non-pulled position).

The rear joint portion 7 includes a battery holder 14 at its rear end. The battery holder 14 is configured so that the battery pack 15 is detachably attached to the battery holder 14. In the first embodiment, the battery holder 14 is configured so that the battery pack 15 is attached to the battery holder 14 by sliding the battery pack 15 from top to bottom at the rear end of the battery holder 14.

The battery pack 15 includes a not shown battery inside. In the first embodiment, the battery has a rated voltage of 36 volts. The battery pack 15 supplies electric power of the battery to the electric-powered lubricant dispenser 1 via the battery holder 14.

The battery holder 14 includes a terminal block 16 inside. The terminal block 16 is configured to be electrically coupled to the battery pack 15 attached to the battery holder 14. In the first embodiment, the terminal block 16 extends in the height direction.

The battery holder 14 houses a control unit 17 at the front of the terminal block 16. In the first embodiment, the control unit 17 extends in the height direction. The control unit 17 includes a control circuit board 18.

In the first embodiment, the motor 20 is an inner rotor type brushless motor (specifically, a three-phase brushless DC motor). In another embodiments, the motor 20 may be any other types of motors (for example, a brushed DC motor).

The motor 20 includes a stator 21. The stator 21 includes three lead wires 27 (FIG. 2 shows only one of the lead wires 27). The stator 21 includes a first insulator 23A at its front end. The stator 21 includes a second insulator 23B at its rear end.

The stator 21 includes three coils 24 wound via the first insulator 23A and the second insulator 23B. The second insulator 23B includes not shown six terminals fused to respective ends of wires in these coils 24.

The second insulator 23B includes a short-circuit member 25. The short-circuit member 25 includes three insert-molded short-circuit fittings 26 (FIG. 2 shows only two of the short-circuit fittings 26). These short-circuit fittings 26 electrically couple the aforementioned terminals of the second insulator 23B so that the aforementioned coils 24 form a delta configuration (or a delta connection). The aforementioned coils 24 may form a star configuration (or a star connection).

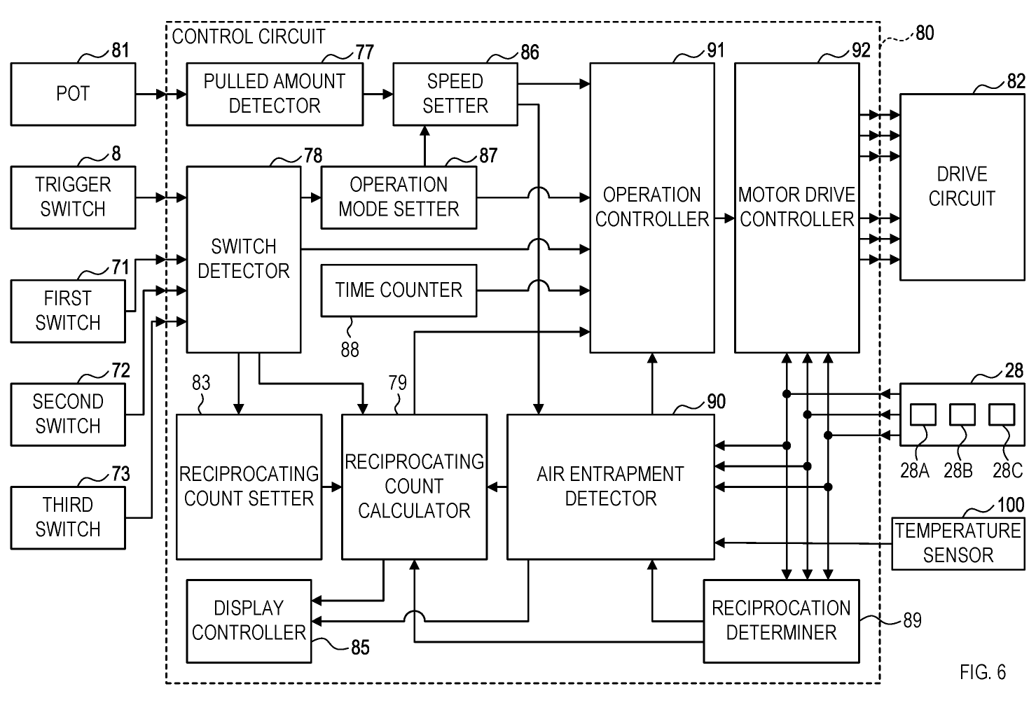

The stator 21 includes a sensor circuit board 28 between the second insulator 23B and the short-circuit member 25. The sensor circuit board 28 includes first through third rotational position sensors 28A through 28C (see FIG. 6). In the first embodiment, the first through third rotational position sensors 28A through 28C are Hall sensors, but are not limited to Hall sensors. The first through third rotational position sensors 28A through 28C are coupled to three signal lines 29 (FIG. 2 shows only one of the signal lines 29). The lead wires 27 and the signal lines 29 are coupled to the control circuit board 18 of the control unit 17.

The motor 20 includes a rotor 22 inside the stator 21. The rotor 22 includes a rotation shaft 30 at its center. The rotation shaft 30 includes two or more permanent magnets 31 embedded in an outer peripheral wall of the rotation shaft 30.

The first through third rotational position sensors 28A through 28C (i) are arranged around the rotor 22 and (ii) respectively output first through third rotation signals corresponding to a rotational position of the rotation shaft 30 (and also a rotational position of the rotor 22).

The rotation shaft 30 includes a fan 32 at its front end. In the first embodiment, the fan 32 extends perpendicular to the rotation shaft 30.

The rear joint portion 7 houses a first bearing 35 at the rear of the short-circuit member 25. The first bearing 35 rotatably supports the rear end of the rotation shaft 30.

The motor container 4 includes a gear housing 40 at the front of the electric motor 20. In the first embodiment, the gear housing 40 has a cylindrical shape. The gear housing 40 has an opening at its rear end. The gear housing 40 includes a bracket plate 41 attached to this opening. The rotation shaft 30 penetrates the bracket plate 41 and protrudes into the gear housing 40. The bracket plate 41 includes a second bearing 42. The second bearing 42 rotatably supports the front end of the rotation shaft 30.

The gear housing 40 includes a spindle 44 at its front end. The gear housing 40 houses a transmission mechanism 43. The transmission mechanism 43 is coupled to the rotation shaft 30 and transmits rotation of the rotation shaft 30 to a pump 60 described later via the spindle 44. The transmission mechanism 43 is configured (i) to receive the rotation of the rotation shaft 30 and (ii) to rotate the spindle 44 at a rotational speed lower than a rotational speed of the rotation shaft 30. In other words, the transmission mechanism 43 reduces the rotational speed of the rotation shaft 30 and transmits the reduced rotational speed to the spindle 44. The transmission mechanism 43 may include a planetary gear.

The housing 2 includes a crank housing 45 at the front end of the gear housing 40. In the first embodiment, the crank housing 45 extends in the height direction. The spindle 44 protrudes into the crank housing 45 from the gear housing 40.

The crank housing 45 houses a crank plate 46 at the front end of the spindle 44. The crank plate 46 includes an eccentric pin 47 protruding to the front.

The crank housing 45 includes a slider 48 at the front of the crank plate 46. The slider 48 has an elongated hole 48A extending in a width direction. The width direction corresponds to a direction from right to left or from left to right of the housing 2. The eccentric pin 47 is inserted into the elongated hole 48A. The slider 48 is coupled to the plunger 50 at the center of its lower end. The plunger 50 includes an upper end coupled to the slider 48 and extends downward.

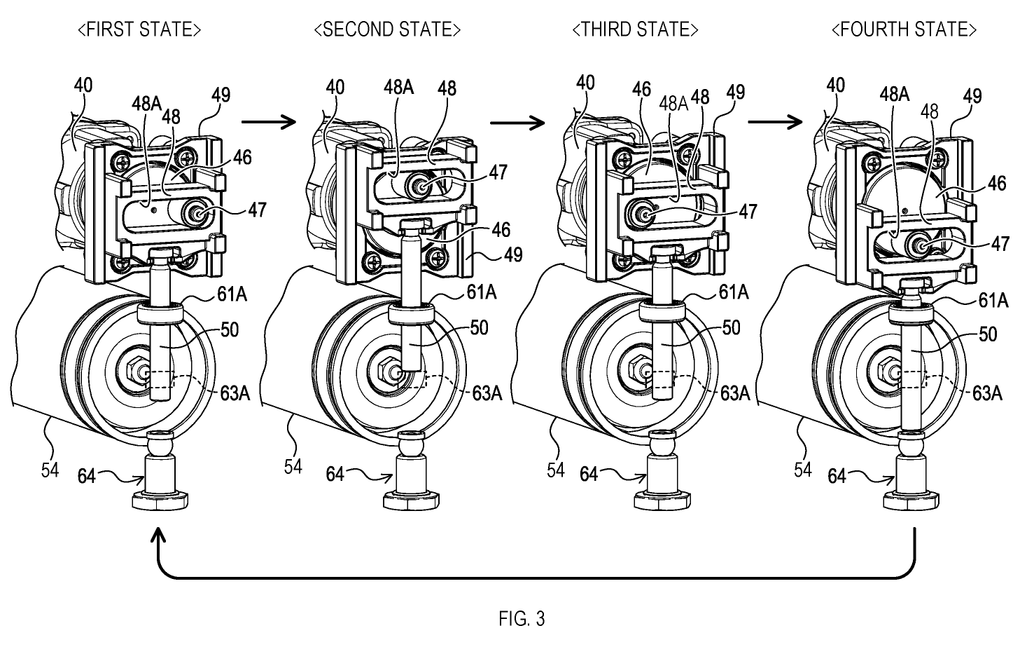

The crank housing 45 includes a slider guide 49 that supports the slider 48 so that the slider 48 can move up and down. The slider 48 and the slider guide 49 are also shown in FIG. 3. The slider 48 is movable in the height direction along the slider guide 49.

In the crank housing 45 configured as above, when the crank plate 46 rotates together with the spindle 44, the eccentric pin 47 performs eccentric movements. Due to strokes in the height direction of the eccentric pin 47, the slider 48 and the plunger 50 move up and down. In other words, the crank plate 46 and slider 48 convert the rotational motion of the motor 20 into linear reciprocating motion.

The crank housing 45 includes a front holder 51 at its lower part. The housing 2 includes a rear holder 52 at the rear of the front holder 51 and at a lower part of the motor container 4. The rear holder 52 includes two legs 53 protruding downward at its front and rear ends.

The electric-powered lubricant dispenser 1 includes a tank 54 supported by the front holder 51 and the rear holder 52. The tank 54 has an open front end. The tank 54 reaches to the rear surface of the front holder 51 through the rear holder 52. The front end of the tank 54 is screwed into the rear surface of the front holder 51. In other words, the tank 54 extends in the length direction below the motor container 4.

The tank 54 houses a rod 55. The rod 55 extends from the rear end of the tank 54 to the front end of the tank 54. The rod 55 holds a piston 56 in a manner movable along the rod 55. The rod 55 has a rear end protruding from the tank 54. The tank 54 includes a handle 57 attached to the rear end of the rod 55. The tank 54 houses a coil spring 58. The coil spring 58 is located at the rear of the piston 56 and biases the piston 56 to the front. The tank 54 houses a not shown cartridge filled with grease at the front of the piston 56. When this cartridge is pressed by the piston 56, grease is delivered into the front holder 51.

The front holder 51 includes a pump 60. The pump 60 includes the aforementioned plunger 50. The pump 60 includes an upper cylindrical portion 60A and a lower cylindrical portion 60B. The upper cylindrical portion 60A and the lower cylindrical portion 60B form a chamber 63. The plunger 50 is inside the chamber 63.

The chamber 63 is provided with an inflow hole 63A between the upper cylindrical portion 60A and the lower cylindrical portion 60B. The chamber 63 communicates with tank 54 via the inflow hole 63A. Grease is supplied from the cartridge into the chamber 63 through the inflow hole 63A.

The upper cylindrical portion 60A is provided with a seal ring 61A at its upper end. The plunger 50 penetrates the seal ring 61A. The seal ring 61A stops or inhibits grease in the chamber 63 from leaking upward from the upper cylindrical portion 60A.

The lower cylindrical portion 60B is provided with a dispensing path 66. The dispensing path 66 (i) communicates with the chamber 63 via a check valve 64 described later and (ii) extends in the length direction. The front holder 51 includes a front cylindrical portion 60C at its front end. The front cylindrical portion 60C protrudes to the front from the front holder 51. The dispensing path 66 passes through the center of the front cylindrical portion 60C. The dispensing path 66 has a dispensing port 66A at its front end. The front cylindrical portion 60C is coupled to a hose 68. The grease is dispensed from the dispensing port 66A to outside the electric-powered lubricant dispenser 1 via the hose 68.

The pump 60 includes the aforementioned check valve 64 at the bottom of the chamber 63. The check valve 64 permits grease to flow out from the chamber 63 to the dispensing path 66, while inhibiting or stopping grease from flowing back from the dispensing path 66 into the chamber 63.

The front cylindrical portion 60C includes a relief valve 69 at its right side portion. The relief valve 69 is configured to discharge the grease inside the dispensing path 66 to outside the electric-powered lubricant dispenser 1 in response to a pressure of the grease inside the dispensing path 66 being larger than or equal to a specified pressure.

The front holder 51 includes an air drain valve 67 at its front end. The air drain valve 67 is provided to discharge gas (e.g., air) in the chamber 63 (specifically near the inflow hole 63A) to outside the electric-powered lubricant dispenser 1. When the air drain valve 67 is tightened, the chamber 63 is sealed off from outside the electric-powered lubricant dispenser 1. The electric-powered lubricant dispenser 1 is normally used with the air drain valve 67 being tightened. When the air drain valve 67 is loosened, the chamber 63 communicates with the outside of the electric-powered lubricant dispenser 1. If gas is present in the chamber 63 at this time, the gas can be discharged to outside the electric-powered lubricant dispenser 1 via the air drain valve 67.

### 2-1-2. Mechanical Operation of Electric-Powered Lubricant Dispenser

In the electric-powered lubricant dispenser 1 configured as above, when the user pulls the trigger 9, the motor 20 rotates, and then the rotation shaft 30 rotates.

Rotation of the rotation shaft 30 is transmitted to the spindle 44 via the transmission mechanism 43, and the crank plate 46 rotates together with the spindle 44. This causes the eccentric pin 47 to perform eccentric movements. In response to the eccentric movements of the eccentric pin 47, (i) the slider 48 moves up and down along the slider guide 49, and (ii) as a result, the plunger 50 reciprocates up and down.

More specifically, as shown in FIG. 3, the plunger 50 moves up and down (specifically, completes one reciprocation) through first to fourth states in this order. FIG. 3 schematically shows the position of the inflow hole 63A.

The first state is a state in which the slider 48 is moving upward. More specifically, the first state is the state where the slider 48 is in an intermediate position within the reciprocating range. FIG. 2 shows the electric-powered lubricant dispenser 1 in the first state. In the first state, as evident from FIG. 2, the plunger 50 is inserted into the lower cylindrical portion 60B. When the motor 20 rotates further from the first state, the electric-powered lubricant dispenser 1 transitions to the second state.

The second state is when the slider 48 reaches its uppermost position in its reciprocating range. Before the slider 48 reaches the uppermost position, a lower end of the plunger 50 exits the lower cylindrical portion 60B, thereby allowing grease to flow from the tank 54 into the chamber 63. In the second state, the lower end of the plunger 50 is either fully contained in the upper cylindrical portion 60A or protrudes slightly downward from the upper cylindrical portion 60A. When the motor 20 rotates further from the second state, the slider 48 moves downward, and the electric-powered lubricant dispenser 1 transitions to the third state.

The third state is a state where the slider 48 is moving downward. Specifically, the third state is when the slider 48 is in an intermediate position in the reciprocating range. In the third state, similar to the first state, the plunger 50 is inserted into the lower cylindrical portion 60B. When the motor 20 rotates further from the third state, the electric-powered lubricant dispenser 1 transitions to the fourth state.

The fourth state is a state when the slider 48 reaches the lowest position in its reciprocating range. In the fourth state, the lower end of the plunger 50 reaches near the bottom of the chamber 63. When the motor 20 rotates further from the fourth state, the slider 48 moves upward, and the electric-powered lubricant dispenser 1 transitions to the first state.

During a period from the second state to the fourth state, the plunger 50 moves downward. During this time, the grease in the chamber 63 is pressed against the bottom surface of the plunger 50 (i.e., surface on a lower end side; hereinafter referred to as “plunger lower end surface”). Consequently, the grease flows into the hose 68 via the check valve 64, the dispensing path 66, and dispensing port 66A, and is dispensed from the hose 68 to outside the electric-powered lubricant dispenser 1.

As above, while the motor 20 rotates, reciprocation of the slider 48 (and consequently reciprocation of the plunger 50) is repeated, causing grease to be continuously dispensed (or able to be dispensed) from the dispensing port 66A. Each time the plunger 50 completes one reciprocation, grease is dispensed. Therefore, one reciprocation of the plunger 50 can be said to be one dispensing operation of grease. One reciprocation of the plunger 50 (that is, one dispensing operation) is an example of a specified dispensing operation in Overview of Embodiments.

The motor 20 may rotate in an opposite direction to that of the operation example shown in FIG. 3. In this case, the plunger 50 moves up and down, passing through the fourth through first states in this order, thereby dispensing grease in the same manner as the operation example in FIG. 3.

### 2-1-3. Detail of Operation Panel

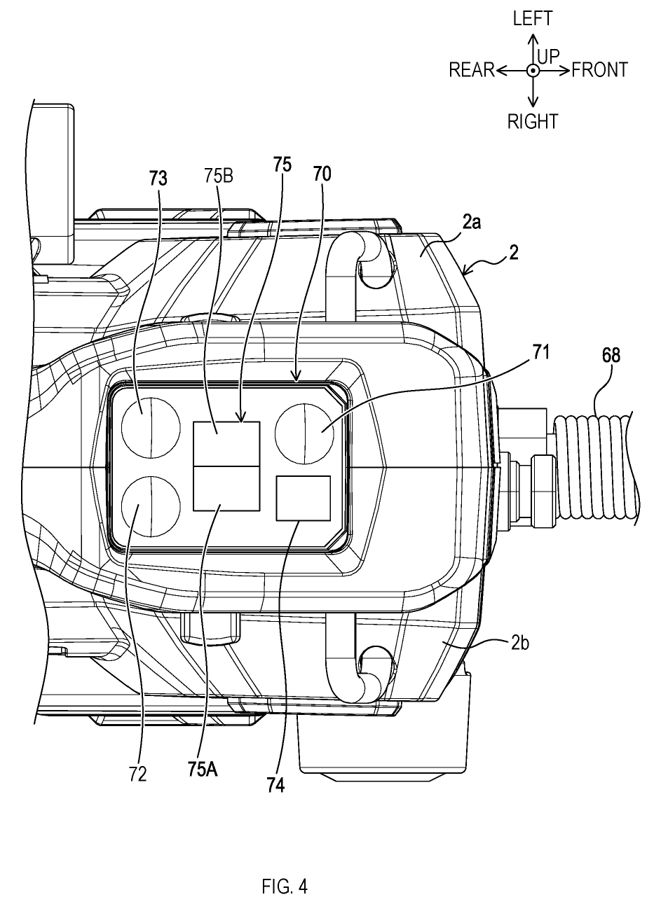

As shown in FIG. 4, the operation panel 70 includes a first switch 71. In the first embodiment, the first switch 71 and second and third switches 72 and 73 described later are pushbutton switches. In another embodiment, the first through third switches 71 through 73 may be other types of manual switches.

Each time the first switch 71 is short pressed, a level of the rotational speed of the motor 20 is sequentially switched (i.e., set) to one of rotational speed ranges (or rotational speed levels). The rotational speed ranges include, for example, first through fourth speed ranges. For each rotational speed range, a maximum rotational speed of the motor 20 is set. The maximum rotational speed increases in the order of, for example, first speed range, second speed range, third speed range, and fourth speed range.

The motor 20 is rotated up to the maximum rotational speed corresponding to the set rotational speed range. Specifically, for example, a desired rotational speed is set depending on an operation mode described later and/or a pulled amount (i.e., position) of the trigger 9, with the set maximum rotational speed as its upper limit. The motor 20 is controlled to maintain a constant rotational speed (in other words, speed feedback controlled) such that its actual rotational speed is consistent with the desired rotational speed.

When the first switch 71 is long pressed, the light 10 turns on. After being turned on, the light 10 may be turned off, for example, when (i) a specified time has elapsed or (ii) the first switch 71 is long pressed again. A short press corresponds to an operation in which the pressing operation is released before a given period of time has elapsed since the pressing begins. A long press corresponds to an operation in which the pressing operation is released after the pressing has been continued for a given period of time or longer.

The operation panel 70 includes a first display screen 74. The first display screen 74 displays information indicating the set rotational speed range (e.g., a numerical value from “1” through “4”). The values “1” through “4” respectively indicate the first to fourth speed ranges. In the first embodiment, the first display screen 74 and second and third display screens 75A and 75B described later are each a seven-segment display. In another embodiment, each of the first through third display screens 74, 75A, and 75B may be other types of display screens including a liquid crystal display (LCD).

The operation panel 70 includes the aforementioned second switch 72 and third switch 73. Each time the second and third switches 72, 73 are pressed simultaneously, the operation mode of the electric-powered lubricant dispenser 1 switches. In the first embodiment, the operation modes include a continuous dispensing mode and an automatic dispensing mode (or a fixed-volume dispensing mode). In the first embodiment, each time the second and third switches 72 and 73 are pressed simultaneously, the operation mode alternately switches between the continuous dispensing mode and the automatic dispensing mode.

In the continuous dispensing mode, the motor 20 continuously rotates while the trigger 9 is pulled. In the first embodiment, the desired rotational speed in the continuous dispensing mode changes depending on the position of the trigger 9. Specifically, the desired rotational speed increases continuously or in steps as the trigger 9 moves from the minimum position to a desired arrival position. More specifically, the desired rotational speed increases from a specified minimum value (e.g., zero) toward the maximum rotational speed corresponding to the set rotational speed range. The desired arrival position may exist between the minimum position and the maximum position, or may coincide with the maximum position. When the trigger 9 reaches the desired arrival position, the desired rotational speed reaches the maximum rotational speed corresponding to the set rotational speed range. When the trigger 9 exists between the desired arrival position and the maximum position, the desired rotational speed is maintained at the maximum rotational speed.

In the continuous dispensing mode, the desired rotational speed may be maintained at a fixed rotational speed (e.g., the maximum rotational speed corresponding to the set rotational speed range) regardless of the position of the trigger 9.

In automatic dispensing mode, rotation of the motor 20 begins in response to the trigger 9 being pulled. After the rotation begins, once the plunger 50 (in other words, the slider 48) has completed a desired reciprocating count, the motor 20 automatically stops, even if the trigger 9 is still being pulled. The plunger completing the desired reciprocating count corresponds to (i) the specified dispensing operation being performed the desired number of times, and/or (ii) an amount of grease corresponding to the desired reciprocating count being dispensed. The desired reciprocating count can be set to any value by the user.

In the automatic dispensing mode, the desired rotational speed is set to a constant rotational speed (e.g., the maximum rotational speed corresponding to the set rotational speed range), regardless of the position of the trigger 9. However, the desired rotational speed in the automatic dispensing mode may change depending on the position of the trigger 9, as in the continuous dispensing mode.

The operation panel 70 includes a set count display screen 75. The set count display screen 75 (i) includes the aforementioned second display screen 75A and the third display screen 75B, and (ii) can display two-digit numbers. When the operation mode is set to the automatic dispensing mode, the desired reciprocating count is displayed on the set count display screen 75.

In the first embodiment, in the automatic dispensing mode, any desired reciprocating count can be set, with a maximum set count serving as an upper limit. The maximum set count may be a specified value, for example, 99 or less. The user can set the desired reciprocating count to any value by operating the second switch 72 or the third switch 73. Specifically, in the automatic dispensing mode, each time the second switch 72 is pressed, (i) the desired reciprocating count increases by one, and (ii) the newly increased desired reciprocating count is displayed on the set count display screen 75. Conversely, in the automatic dispensing mode, each time the third switch 73 is pressed, (i) the desired reciprocating count decreases by one, and (ii) the decreased new desired reciprocating count is displayed on the set count display screen 75. The maximum set count may be determined in any manner, and may be, for example, a specified value of 99 or less, or a specified value of 100 or more.

### 2-1-4. Electrical Configuration of Electric-Powered Lubricant Dispenser

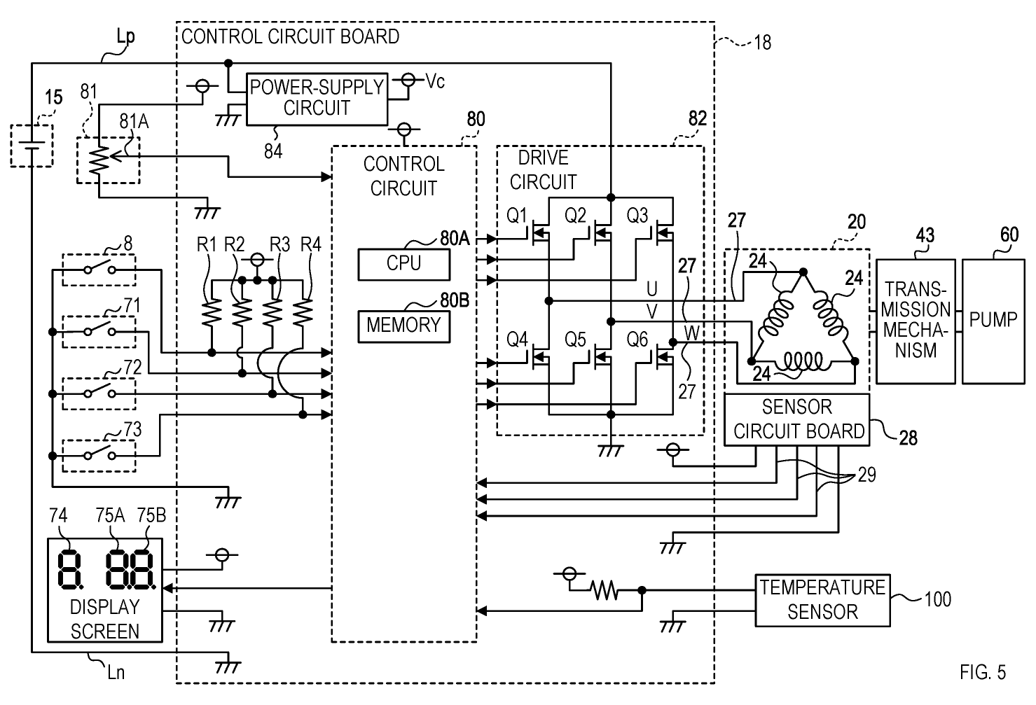

Referring to FIG. 5, the electrical configuration of the electric-powered lubricant dispenser 1 is described. The electric powered-lubricant dispenser 1 includes a control circuit board 18. The control circuit board 18 includes a ground. The electric-powered lubricant dispenser 1 includes a power supply line Lp. The power supply line Lp extends from a positive electrode connection terminal (not shown) onto the control circuit board 18. The positive electrode connection terminal is coupled to a positive electrode of the battery pack 15 while the battery pack 15 is attached to the battery holder 14. The electric-powered lubricant dispenser 1 includes a ground line Ln. The ground line Ln extends from a negative electrode connection terminal (not shown) to the ground on the control circuit board 18. The negative electrode connection terminal is coupled to a negative electrode of the battery pack 15 while the battery pack 15 is attached to the battery holder 14. The battery pack 15 applies its rated voltage between the power supply line Lp and the ground line Ln.

The electric-powered lubricant dispenser 1 includes a power-supply circuit 84. In the first embodiment, the power-supply circuit 84 is on the control circuit board 18. The power-supply circuit 84 is coupled to the power supply line Lp and the ground. The power-supply circuit 84 generates a fixed DC voltage (hereinafter, referred to as “power-supply voltage”) Vc based on the battery voltage supplied from the battery pack 15.

The electric-powered lubricant dispenser 1 includes a control circuit 80. The control circuit 80 is disposed on the control circuit board 18, and operates with the power-supply voltage Vc. The control circuit 80 is a microcomputer including a CPU (or a processor) 80A, and a semiconductor memory 80B. The semiconductor memory 80B includes a ROM, a RAM, and a rewritable non-volatile memory. Examples of the rewritable non-volatile memory include an EEPROM, a flash memory, a ReRAM, and a FeRAM. Various functions of the control circuit 80 are achieved by the CPU 80A executing a program stored in the semiconductor memory 80B. As a result of the CPU 80A executing the program, a method corresponding to this program is performed.

In another embodiment, the control circuit 80 may include an additional microcomputer. In further another embodiment, part or all of the functions achieved by the CPU 80A may be achieved by one or more electronic components (for example, an integrated circuit). In further another embodiment, the control circuit 80 may be a logic circuit (or a wired logic connection) including two or more electronic components. In further another embodiment, the control circuit 80 may include an ASIC and/or an ASSP. In further another embodiment, the control circuit 80 may include a programmable logic device in which a reconfigurable logic circuit(s) can be built. Examples of the programmable logic device include an FPGA.

The electric-powered lubricant dispenser 1 includes a drive circuit 82. The drive circuit 82 is configured to supply electric current (hereinafter referred to as “motor current”) to the motor 20 to drive the motor 20. The drive circuit 82 is electrically coupled to the power supply line Lp and the ground line Ln. The drive circuit 82 (i) receives the battery voltage, (ii) generates a three-phase voltage (i.e., generates three-phase power) from that battery voltage, and (iii) supplies that three-phase voltage to the motor 20. In the first embodiment, the drive circuit 82 is disposed on the control circuit board 18.

The drive circuit 82 is a three-phase full-bridge circuit, but is not limited to a three-phase full-bridge circuit. The drive circuit 82 includes first through third switches Q1 through Q3 arranged on a high side and fourth through sixth switches Q4 through Q6 arranged on a low side. Each of the first through third switches Q1 through Q3 is coupled to the power supply line Lp and a corresponding lead wire 27, functioning as so-called high-side switches. Each of the fourth through sixth switches Q4 through Q6 is coupled to a corresponding lead wire 27 and to the ground, functioning as so-called low-side switches.

The first through sixth switches Q1 through Q6 respectively receive first through sixth drive control signals from the control circuit 80. Each of the first through sixth switches Q1 through Q6 turns on or off in accordance with the corresponding drive control signal received. In the first embodiment, each of first through sixth drive control signals may be a pulse width modulated signal. In the first embodiment, each of the first through sixth switches Q1 through Q6 is a semiconductor switch. Examples of the semiconductor switch include a field-effect transistor (FET), a bipolar transistor, and an insulated-gate bipolar transistor (IGBT).

When the motor 20 is driven, basically one high-side switch (i.e., one of switches Q1 through Q3) and one low-side switch (i.e., one of switches Q4 through Q6) are turned on. This allows the motor current to flow from the positive electrode of the battery, through the high-side switch, the motor 20, and the low-side switch, to the negative electrode of the battery, thereby rotating the motor 20.

The electric-powered lubricant dispenser 1 includes a potentiometer 81 having a lever 81A. The lever 81A has a displaceable first end and a second end coupled to the control circuit 80. The potentiometer 81 has a resistance value that changes depending on a position of the first end of the lever 81A. The second end of the lever 81A outputs a voltage (hereinafter referred to as “trigger voltage”) having a magnitude corresponding to the resistance value to the control circuit 80. The first end of the lever 81A is displaced in accordance with the position of the trigger 9 within the range from the initial position to the maximum position. For example, the resistance value of the potentiometer 81 is minimum when the trigger 9 is in the initial position and increases as the trigger 9 approaches the maximum position from the initial position.

The electric-powered lubricant dispenser 1 includes first through fourth pull-up resistors R1 through R4. In the first embodiment, the first through fourth pull-up resistors R1 through R4 are on the control circuit board 18. Each of the first through fourth pull-up resistors R1 through R4 has a first end coupled to the power-supply circuit 84 so as to receive the power-supply voltage Vc from the power-supply circuit 84. The first pull-up resistor R1 has a second end coupled to the first end of the trigger switch 8 and the control circuit 80. The second pull-up resistor R2 has a second end coupled to a first end of the first switch 71 and the control circuit 80. The third pull-up resistor R3 has a second end coupled to a first end of the second switch 72 and the control circuit 80. The fourth pull-up resistor R4 has a second end coupled to a first end of the third switch 73 and the control circuit 80. The trigger switch 8, the first switch 71, the second switch 72, and the third switch 73 each have a second end coupled to the ground on the control circuit board 18.

When the trigger switch 8, the first switch 71, the second switch 72, and the third switch 73 are off, the second ends of the first through the fourth pull-up resistors R1 through R4 have a voltage level equal to the power-supply voltage Vc (i.e., a high level). When the trigger switch 8, the first switch 71, the second switch 72, and the third switch 73 are on, the second ends of the first through fourth pull-up resistors R1 through R4 have a voltage at the same level as the ground (i.e., a low level). The first through fourth pull-up resistors R1 through R4 may have the same resistance value or may have different resistance values.

The control circuit 80 can detect whether the trigger 9, the first switch 71, the second switch 72, and the third switch 73 are manually operated based on the voltages at the second ends of the first through fourth pull-up resistors R1 through R4. Specifically, when the voltages at the second ends of the first through fourth pull-up resistors R1 through R4 are high, the control circuit 80 detects that the trigger 9, the first switch 71, the second switch 72, and the third switch 73 are not manually operated. If the voltages at the second end of the first through fourth pull-up resistors R1 through R4 are low, the control circuit 80 detects that the trigger 9, the first switch 71, the second switch 72, and the third switch 73 are manually operated.

The control circuit board 18 is coupled to the first through third display screens 74, 75A, and 75B of the operation panel 70. The first through third display screens 74, 75A, and 75B operate by receiving the power-supply voltage Vc from the control circuit board 18. Furthermore, the first through third display screens 74, 75A, 75B each receive first through third display control signals from the control circuit 80 and display the information.

The control circuit board 18 is coupled to the sensor circuit board 28. The first through third rotational position sensors 28A through 28C on the sensor circuit board 28 operate by receiving the power-supply voltage Vc from the control circuit board 18. The first through third rotational position sensors 28A through 28C are coupled to the control circuit 80 via the signal lines 29 and output first through third rotation signals to the control circuit 80. The first through third rotation signals are associated with respective three phases (namely, the U phase, V phase, and W phase) of the motor 20. The first through third rotation signals have a phase difference of 120 electrical degrees relative to each other. The first through third rotation signals may be, for example, sine wave signals. In this case, a voltage of each of the first through third rotation signals reverses from positive to negative or from negative to positive every time the rotor 22 rotates 180 electrical degrees. The first through third rotation signals may, for example, be square wave signals. In this case, a logic value of each of the first through third rotation signals reverses every time the rotor 22 rotates 180 electrical degrees.

In another embodiment, the sensor circuit board 28 may be configured to output a single rotation detection signal (e.g., a pulse signal) to the control circuit 80 instead of the first through third rotation signals. The rotation detection signal changes each time the rotor 22 rotates 60 electrical degrees.

The electric-powered lubricant dispenser 1 includes a temperature sensor 100 coupled to the control circuit 80. The temperature sensor 100 is provided to detect the temperature of the electric-powered lubricant dispenser 1. More specifically, the temperature sensor 100 is provided to directly or indirectly detect the temperature of the grease. The temperature sensor 100 outputs a temperature detection signal indicating the detected temperature to the control circuit 80. The temperature sensor 100 may be in any form capable of detecting the temperature. The temperature sensor 100 may, for example, include a positive temperature coefficient (PTC) thermistor, a negative temperature coefficient (NTC) thermistor, or a critical temperature resistor (CTR) thermistor.

The temperature sensor 100 may be positioned to directly or indirectly detect the temperature (or the level) of the grease. For example, the temperature sensor 100 may be disposed in a position where the temperature sensor 100 can come into direct contact with the grease. More specifically, the temperature sensor 100 may be disposed, for example, at an inlet (e.g., inflow port 63A) of the pump 60.

Alternatively, the temperature sensor 100 may be disposed in a position not in contact with the grease. Specifically, the temperature sensor 100 may be disposed, for example, on a surface or inside of the grip 5, around the front holder 51, or near the tank 54 in the housing 2.

### 2-1-5. Functional Configuration of Electric-Powered Lubricant Dispenser

Referring to FIG. 6, functions of the control circuit 80 will be described. The control circuit 80 includes functions of a pulled amount detector 77, a switch detector 78, a reciprocating count setter 83, a reciprocating count calculator 79, a display controller 85, a speed setter 86, an operation mode setter 87, a time counter (or timer) 88, a reciprocation determiner 89, an air entrapment detector 90, an operation controller 91, and a motor drive controller 92. In the first embodiment, these functions are incorporated into the control circuit 80 by software. That is, these functions are achieved by the CPU 80A executing corresponding programs (specifically, a main process described later).

In another embodiment, at least any one of the functions of the pulled amount detector 77, the switch detector 78, the reciprocating count setter 83, the reciprocating count calculator 79, the display controller 85, the speed setter 86, the operation mode setter 87, the time counter 88, the reciprocation determiner 89, the air entrapment detector 90, the operation controller 91, and motor drive controller 92 may be incorporated into the control circuit 80 by hardware (electronic circuit), not by software. In another embodiment, at least any one of the functions of the pulled amount detector 77, the switch detector 78, the reciprocating count setter 83, the reciprocating count calculator 79, the display controller 85, the speed setter 86, the operation mode setter 87, the time counter 88, the reciprocation determiner 89, the air entrapment detector 90, the operation controller 91, and the motor drive controller 92 may be removed.

The pulled amount detector 77 receives the trigger voltage from the potentiometer 81. The pulled amount detector 77 detects an actual pulled amount of the trigger 9 based on the trigger voltage. The actual pulled amount is an actual distance the trigger 9 has been pulled (i.e., actual position of the trigger 9). The pulled amount detector 77 detects the actual pulled amount of zero when the magnitude of the trigger voltage corresponds to the initial position of the trigger 9. The pulled amount detector 77 detects a maximum actual pulled amount when the magnitude of the trigger voltage corresponds to the maximum position of the trigger 9. The pulled amount detector 77 detects the actual pulled amount between zero and the maximum value when the magnitude of the trigger voltage corresponds to the intermediate position of the trigger 9. The intermediate position is between the initial position and the maximum position. The pulled amount detector 77 outputs the detected actual pulled amount to the speed setter 86.

The switch detector 78 detects changes from off to on and from on to off of each of the trigger switch 8, the first switch 71, the second switch 72, and the third switch 73. The switch detector 78 outputs a first signal to the operation controller 91 and the reciprocating count calculator 79 in response to the trigger switch 8 changing from off to on. The first signal indicates that the trigger switch 8 has changed from off to on. The switch detector 78 outputs a second signal to the operation controller 91 and the reciprocating count calculator 79 in response to the trigger switch 8 changing from on to off. The second signal indicates that the trigger switch 8 has changed from on to off. The switch detector 78 outputs a third signal to the operation mode setter 87 in response to the first switch 71 changing from off to on. The third signal indicates that the first switch 71 has changed from off to on. The switch detector 78 outputs a fourth signal to the operation mode setter 87 in response to simultaneous on of the second switch 72 and the third switch 73. The simultaneous on means changing from off to on simultaneously or nearly simultaneously. The fourth signal indicates that the second switch 72 and the third switch 73 have simultaneously turned on.

The switch detector 78 outputs a fifth signal to the reciprocating count setter 83 in response to the second switch 72 changing from off to on while the third switch 73 is off. The fifth signal indicates that the second switch 72 has changed from off to on. While the second switch 72 is off, the switch detector 78 outputs a sixth signal to the reciprocating count setter 83 in response to the third switch 73 changing from off to on. The sixth signal indicates that the third switch 73 has changed from off to on.

The operation mode setter 87 sets the rotational speed range of the motor 20 in response to the input third signal. Specifically, each time the third signal is input, the operation mode setter 87 changes the rotational speed range in the following order: the first speed range, the second speed range, the third speed range, the fourth speed range, the first speed range,

The operation mode setter 87 sets the operation mode of the electric-powered lubricant dispenser 1 to either the continuous dispensing mode or the automatic dispensing mode in response to the input of the fourth signal. Specifically, the operation mode setter 87 alternately switches the operation mode between the continuous dispensing mode and the automatic dispensing mode each time the fourth signal is input.

The operation mode setter 87 outputs the set operation mode to the speed setter 86, the reciprocating count setter 83, the reciprocating count calculator 79, and the operation controller 91. In FIG. 6, arrows from the operation mode setter 87 to the reciprocating count setter 83 and the reciprocating count calculator 79 are omitted. The operation mode setter 87 outputs the set rotational speed range to the speed setter 86 and the display controller 85. In FIG. 6, an arrow from the operation mode setter 87 to the display controller 85 is omitted.

The speed setter 86 sets the desired rotational speed of the motor 20 based on the input actual pulled amount, rotational speed range, and operation mode. The speed setter 86 notifies the operation controller 91 and the air entrapment detector 90 of the set desired rotational speed. The rotational speed of the motor 20 is proportional to a dispensing speed. The dispensing speed is a speed at which the grease is dispensed from the dispensing port 66A, or in other words, the amount of grease dispensed per unit time. Therefore, setting the desired rotational speed is equivalent to setting the desired value of the dispensing speed.

Specifically, when the operation mode is set to the continuous dispensing mode, the speed setter 86 sets the desired rotational speed to a value corresponding to the actual pulled amount within a settable range. The settable range extends from a minimum value (e.g., zero) to a maximum rotational speed corresponding to the rotational speed range. On the other hand, when the operation mode is set to the automatic dispensing mode, the speed setter 86 maintains the desired rotational speed at a constant speed (e.g., the maximum rotational speed corresponding to the rotational speed range).

In the first embodiment, at startup of the motor 20, the desired rotational speed is not immediately set to a specified set value. The desired rotational speed gradually increases toward the specified set value after the startup of the motor 20. The specified set value is the desired rotational speed corresponding to the position of the trigger 9 in the continuous dispensing mode, and the aforementioned constant desired rotational speed in the automatic dispensing mode. However, the desired rotational speed may be set immediately to the specified set value at the startup of the motor 20.

The reciprocating count setter 83 sets the desired reciprocating count of the plunger 50 (in other words, the desired number of dispensing operations) based on the input fifth signal and sixth signal when the operation mode is set to the automatic dispensing mode. Specifically, each time the reciprocating count setter 83 receives the fifth signal, the desired reciprocating count is increased by one from the current value. The reciprocating count setter 83 decreases the desired reciprocating count by one from the current value each time the sixth signal is received. The latest desired reciprocating count may be maintained (i.e., stored) at all times. Alternatively, the desired reciprocating count may be set to an initial value (e.g., zero) each time the battery pack 15 is attached to the electric-powered lubricant dispenser 1 (i.e., each time the control circuit 80 is activated). In the first embodiment, the desired reciprocating count is set to one of, for example, 0 to 99. The reciprocating count setter 83 outputs the set desired reciprocating count to the reciprocating count calculator 79. The desired reciprocating count is one example of the desired dispensing count in Overview of Embodiments.

The reciprocation determiner 89 receives the first through third rotation signals from the first through third rotation position sensors 28A through 28C. The reciprocation determiner 89 counts the number of rotations of the motor 20 based on the first through third rotation signals. The reciprocation determiner 89 determines whether the plunger 50 has completed one reciprocation (i.e., whether one dispensing operation has been performed) based on the number of rotations of the motor 20 and a reduction ratio of the transmission mechanism 43. Each time the reciprocation determiner 89 determines that the plunger 50 has completed one reciprocation (i.e., one dispensing operation has been performed), a reciprocation determination signal is output to the reciprocating count calculator 79 and the air entrapment detector 90.

The air entrapment detector 90 detects air entrapment (or gas entrapment) when the operation mode is set to the automatic dispensing mode. However, the air entrapment detector 90 may also detect air entrapment when the operation mode is set to the continuous dispensing mode. Due to various factors, gas (e.g., air or its bubbles) may be introduced into the chamber 63. Gas may be introduced, for example, during attachment or removal of the cartridge. Alternatively, gas may be present with the grease inside the cartridge from the outset.

When entering the chamber 63, gas repeatedly expands and compresses as the plunger 50 reciprocates. Consequently, during a downward movement of the plunger 50, the check valve 64 may fail to open (or may be difficult to open), potentially stopping the grease from being dispensed (or making the grease difficult to be dispensed). Air entrapment refers to (i) a situation as such, and/or (ii) presence of gas in the chamber 63 itself, and/or (iii) a state in which the pump 60 is attempting to discharge that gas.

The air entrapment detector 90 notifies the reciprocating count calculator 79, the display controller 85, the time counter 88, and the operation controller 91 of a detection result of the air entrapment. Specifically, the air entrapment detector 90 determines whether air entrapment has occurred each time the plunger 50 completes one reciprocation. If no air entrapment has occurred, an air entrapment detection state is set to “Not Detected.” If air entrapment has occurred, the air entrapment detection state is set to “Detected.” The reciprocating count calculator 79, the display controller 85, the time counter 88, and the operation controller 91 can determine whether air entrapment has occurred based on the set air entrapment detection state.

Air entrapment can be detected based on an actual operating amount (or an actual operating quantity) of the motor 20. The actual operating amount may be the actual rotational speed of the motor 20 or the magnitude of fluctuation in the actual rotational speed. Examples of the magnitude of fluctuation in the actual rotational speed include the amplitude of the actual rotational speed and the derivative value of the actual rotational speed.

A load is applied to the plunger 50 (particularly to a lower end surface of the plunger) from outside the plunger 50 in accordance with the reciprocating motion of the plunger 50. Hereinafter, this load is referred to as “plunger load.” The plunger load acts in a direction that hinders the reciprocating motion of the plunger 50.

Typically, the plunger load during dispensing of grease (i.e., while the plunger 50 moves downward and pressurizes the grease) is greater than the plunger load during flowing of grease into the chamber 63 (i.e., while the plunger 50 moves upward). Consequently, the plunger load fluctuates periodically. One fluctuation cycle corresponds to one reciprocation of the plunger 50.

The fluctuation in the plunger load can be reflected on the actual rotational speed. Specifically, an increase in plunger load can cause the actual rotational speed to decrease. Conversely, a decrease in the plunger load can cause the actual rotational speed to increase.

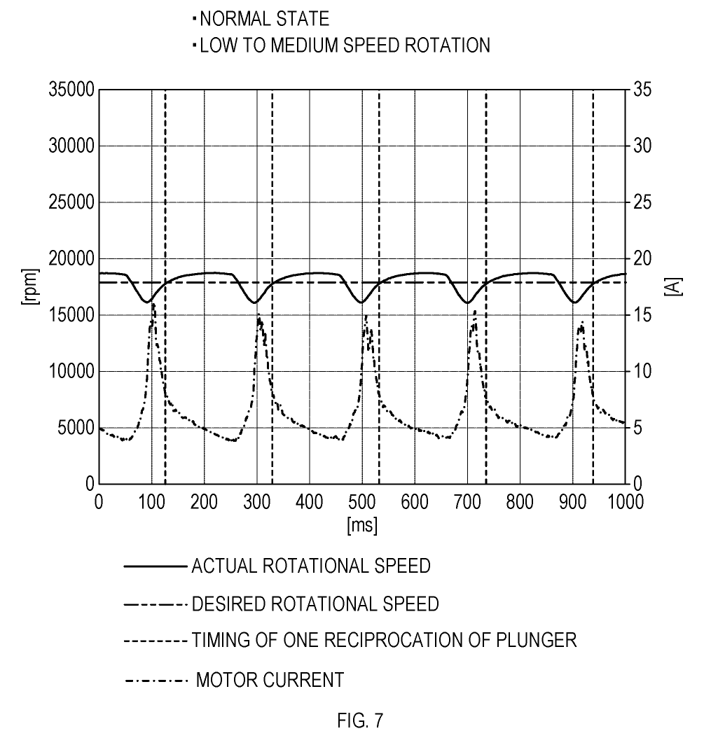

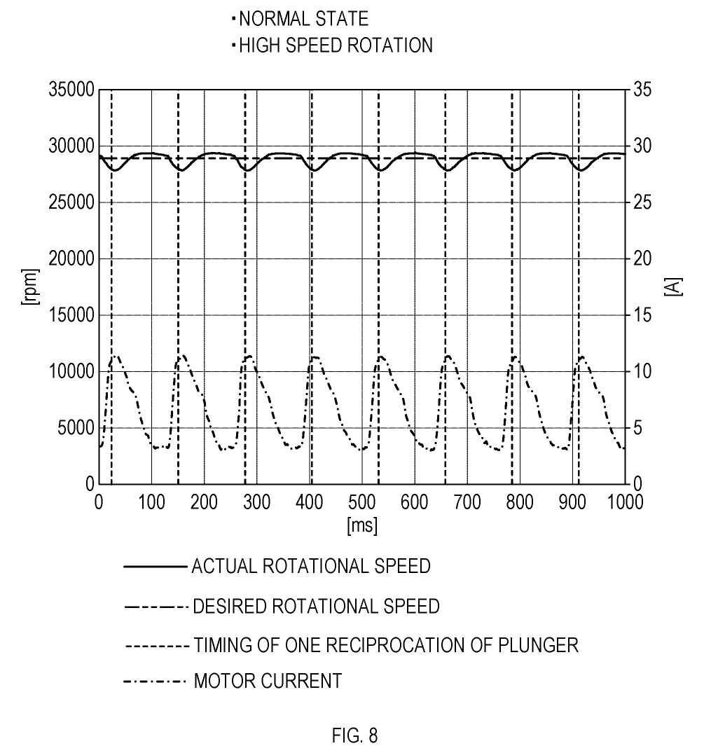

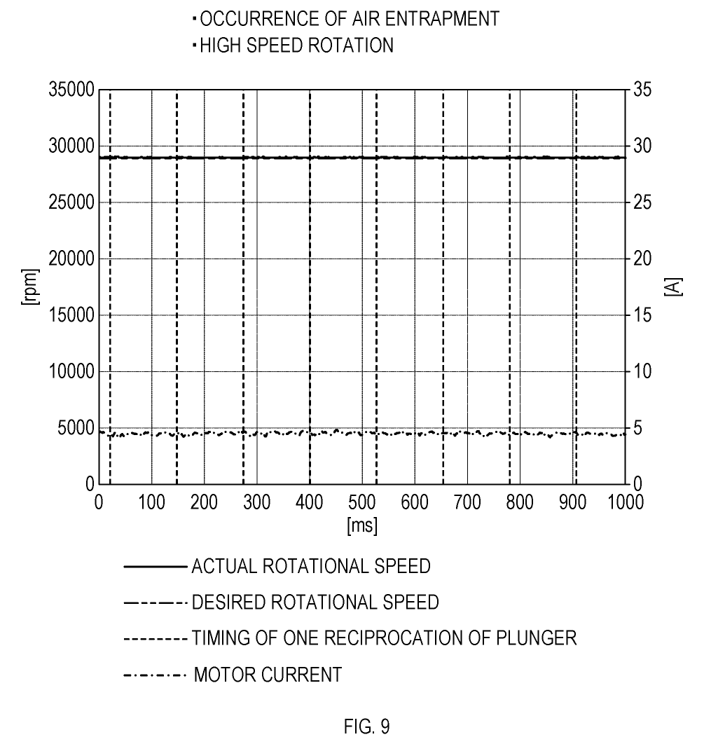

Therefore, the actual rotational speed can change periodically, as exemplified in FIGS. 7 and 8. FIG. 7 shows an example of changes in the actual rotational speed and the motor current when (i) the pump 60 is in the normal state and (ii) the motor 20 is rotating in a low-speed to medium-speed range. FIG. 8 shows an example of changes in the actual rotational speed and the motor current when (i) the pump 60 is in the normal state and (ii) the motor 20 is rotating in a high-speed range. The motor current is a current supplied from the drive circuit 82 to the motor 20. The normal state of the pump 60 includes a state where no air entrapment has occurred. Note that each “timing of one reciprocation of the plunger” in FIG. 7 is a timing when the plunger 50 has reached a specified position (e.g., the uppermost position) in that reciprocation. The same applies to “timing of one reciprocation of the plunger” in FIGS. 8 and 9.

Fluctuation in the actual rotational speed generally increases as the actual rotational speed becomes higher (i.e., as the desired rotational speed increases). FIG. 7 illustrates an example of the actual rotational speed when the desired rotational speed is around 18,000 rpm. As the desired rotational speed becomes higher, fluctuation in the actual rotational speed also becomes larger. However, in the high-speed range, an inertial force of the pump 60 increases. This inertial force acts to suppress a decrease in the actual rotational speed caused by increased plunger load. Consequently, in the high-speed range, as the actual rotational speed increases, the fluctuation in the actual rotational speed conversely becomes smaller.

Furthermore, fluctuation in the plunger load in a state where air entrapment has occurred (hereinafter referred to as the “air entrapped state”) is smaller than that in the normal state. This is because, in the air entrapped state (or gas entrapped state), the entrapped gas is compressed during a descent of the plunger 50. Consequently, the plunger load is smaller compared to when only grease is compressed.

Therefore, the fluctuation in the actual rotational speed in the air entrapped state is also smaller than that in the normal state. FIG. 9 shows an example of changes in the actual rotational speed and the motor current when (i) in the air entrapped state and (ii) the motor 20 is rotating in the high-speed range. As evident by comparing FIGS. 8 and 9, even when the desired rotational speed is the same, the fluctuations in the actual rotational speed and the motor current in the air entrapped state are smaller than those in the normal state.

Thus, the fluctuation in the actual rotational speed differs depending on whether air entrapment has occurred. Consequently, occurrence of air entrapment can be detected based on the fluctuation in the actual rotational speed.

Furthermore, it is also possible to detect the occurrence of air entrapment based on the actual rotational speed itself. Specifically, in the normal state, the plunger 50 experiences a relatively larger load compared to that in the air entrapped state. Consequently, for the same desired rotational speed, the actual rotational speed in the normal state can be lower than that in the air entrapped state. Therefore, air entrapment can be detected based on the actual rotational speed.

Thus, air entrapment can be detected based on various actual operating amounts. Therefore, in the first embodiment, the air entrapment detector 90 determines that air entrapment has occurred based on the actual operating amount satisfying a specified requirement. The specified requirement may be any requirement indicating (or allowing determination) that air entrapment has occurred or may have occurred. In other words, the specified requirement may be any requirement indicating that gas is present or may be present in the pump 60 (specifically, for example, in the chamber 63).

More specifically, the air entrapment detector 90 of the first embodiment determines whether air entrapment has occurred based on the amplitude of the actual rotational speed. As mentioned above, the actual rotational speed may fluctuate periodically during operation of the pump 60. That is, fluctuation in the amplitude of the actual rotational speed occurs during operation of the pump 60.

Therefore, the air entrapment detector 90 detects occurrence of air entrapment based on the amplitude of the actual rotational speed within a specified drive period. The specified drive period may be any period during driving of the motor 20. In the first embodiment, the specified drive period is a period during which the plunger 50 completes one reciprocation. The air entrapment detector 90 determines whether air entrapment has occurred based on the amplitude of the actual rotational speed during that one reciprocation, each time the specified drive period elapses (i.e., each time the plunger 50 completes one reciprocation).

The amplitude of the actual rotational speed in the air entrapped state is smaller than the amplitude in the normal state. Therefore, the air entrapment detector 90 determines that air entrapment has occurred when a maximum value of the amplitude within the specified drive period is less than or equal to the first threshold. In other words, the aforementioned specified requirement includes the maximum value of the amplitude within the specified drive period being less than or equal to the first threshold. The maximum value of the amplitude within the specified drive period is a difference between the maximum and minimum values of the actual rotational speed within the specified drive period.

The first threshold may be set to a value smaller than a first expected range and larger than a second expected range. The first expected range is a range of the amplitude expected in the normal state. The second expected range is a range of the amplitude expected in the air entrapped state. The first threshold may be determined in any manner.

The first threshold may be a fixed value or may be variably set in accordance with the operating state of the electric-powered lubricant dispenser 1. In the first embodiment, the first threshold is variably set depending on the operating state.

In the first embodiment, the operating state includes the desired rotational speed. That is, the air entrapment detector 90 sets the first threshold based on the current desired rotational speed notified from the speed setter 86.

The actual rotational speed changes in response to changes in the desired rotational speed. When the actual rotational speed changes, the amplitude of the actual rotational speed also changes. That is, the plunger load tends to increase as the actual rotational speed becomes higher. Furthermore, the lower the actual rotational speed, the smaller the fluctuation in the plunger load, and the fluctuation in the actual rotational speed is also reduced more effectively by a speed feedback control. Therefore, as the actual rotational speed increases, the fluctuation in the actual rotational speed also becomes larger. Consequently, the first threshold may be set to increase as the desired rotational speed increases.

However, as mentioned earlier, the inertial force of the pump 60 becomes larger in the high-speed range. Therefore, as the actual rotational speed increases, the fluctuation in the actual rotational speed conversely becomes smaller.

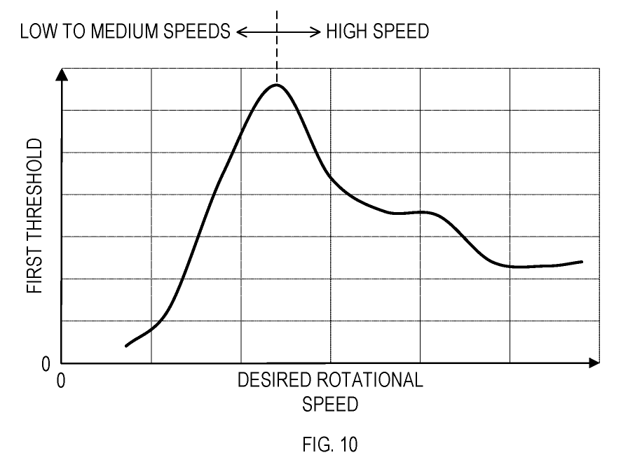

Therefore, the first threshold may be set such that, for example, (i) in a low-speed to medium-speed range, the first threshold increases as the desired rotational speed increases, and (ii) in the high-speed range, the first threshold decreases as the desired rotational speed increases. More specifically, the first threshold may be set in accordance with the desired rotational speed, as illustrated in FIG. 10.

The operating state may include the actual rotational speed. In other words, the first threshold may be set in accordance with the actual rotational speed. In that case as well, the first threshold may be set in the same manner as setting the first threshold in accordance with the desired rotational speed. For example, a horizontal axis in FIG. 10 may be interpreted as the actual rotational speed.

The operating state may also include the aforementioned duty ratio. In other words, the first threshold may be set in accordance with the duty ratio. The first threshold may vary in accordance with the duty ratio. For example, the first threshold may increase as the duty ratio increases. Also, for example, the first threshold may be set in the same manner as setting the first threshold in accordance with the desired rotational speed. For example, the horizontal axis in FIG. 10 may be interpreted as the duty ratio.

Furthermore, the operating state may include a device temperature. In other words, the first threshold may be set in accordance with the device temperature. The device temperature is the temperature of the electric-powered lubricant dispenser 1. Specifically, the device temperature may be the temperature of the grease, or a temperature indirectly indicating the temperature of the grease.

Viscosity of the grease changes with its temperature. For example, as the temperature of the grease increases, the viscosity of the grease decreases. When the viscosity of the grease decreases, the plunger load decreases, thereby reducing the amplitude of the actual rotational speed. Therefore, the first threshold may be set to decrease as the temperature of the grease increases. The air entrapment detector 90 may receive the temperature detection signal from the temperature sensor 100 and set the first threshold in accordance with the temperature indicated by the temperature detection signal.

The time counter 88 measures an air entrapment duration when air entrapment occurs. The air entrapment duration is time during which air entrapment continues. Specifically, the time counter 88 begins measuring the air entrapment duration when the air entrapment detection state changes from “Not Detected” to “Detected”. Specifically, the time counter 88 accumulates (cumulatively adds) a count value incrementally at each calculation timing. When the air entrapment duration reaches a specified time (i.e., when the count value reaches a specified value), the time counter 88 notifies the operation controller 91 that air entrapment has been continuing for the specified time. Specifically, the time counter 88 sets an air entrapment continuation state to “Detected”. The calculation timing occurs repeatedly in a control cycle.

The reciprocating count calculator 79 calculates the actual reciprocating count of the plunger 50 when the operation mode is set to the automatic dispensing mode. The reciprocating count calculator 79 may also calculate the reciprocating count when the operation mode is set to the continuous dispensing mode. The actual reciprocating count is the actual number of reciprocations of the plunger 50. In other words, the actual reciprocating count is the number of times the dispensing operation was actually performed. Therefore, the actual reciprocating count can be rephrased as an actual dispensing count. The actual reciprocating count is an example of the actual dispensing count in Overview of Embodiments.

The reciprocating count calculator 79 accumulates (i.e., cumulatively adds) the actual reciprocating count each time a reciprocation determination signal is received from the reciprocation determiner 89 (i.e., each time the plunger 50 completes one reciprocation). Specifically, each time the reciprocating count calculator 79 receives a reciprocation determination signal, the actual reciprocating count is updated, adding “1” to the current value.

However, the reciprocating count calculator 79 does not update the actual reciprocating count while air entrapment is detected by the air entrapment detector 90 (i.e., while the air entrapment detection state is set to “Detected”). In other words, the reciprocating count calculator 79 temporarily stops accumulation of the actual reciprocating count. After temporarily stopping the accumulation of the actual reciprocating count, the reciprocating count calculator 79 resumes the accumulation from the value at the time of temporary stop once the air entrapment is resolved and the air entrapment detection state is set to “Not Detected”.

The reciprocating count calculator 79 notifies the display controller 85 of the current actual reciprocating count. Furthermore, the reciprocating count calculator 79 outputs a reciprocating count difference to the operation controller 91. The reciprocating count difference is the difference between the desired reciprocating count and the current actual reciprocating count.

In the continuous dispensing mode, the operation controller 91 instructs the motor drive controller 92 to drive the motor 20 while the trigger switch 8 is on. Specifically, the operation controller 91 outputs a drive command to the motor drive controller 92 and notifies the motor drive controller 92 of the current desired rotational speed. The drive command requests the motor drive controller 92 to drive the motor 20.

In the automatic dispensing mode, the operation controller 91 instructs the motor drive controller 92 to drive the motor 20 while the trigger switch 8 is on. Specifically, the operation controller 91 outputs a drive command to the motor drive controller 92 and notifies the motor drive controller 92 of the current desired rotational speed. When the reciprocating count difference notified by the reciprocating count calculator 79 reaches zero, output of the drive command is stopped to stop the motor 20.

During operation in the automatic dispensing mode, if the time counter 88 sets the air entrapment continuation state to “Detected” (meaning that air entrapment has continued for a specified time), the operation controller 91 stops outputting the drive command and stops the motor 20, even if the trigger switch 8 is on and the reciprocating count difference has not yet reached zero.

The motor drive controller 92 calculates the rotational position (specifically, the electrical angle) and the actual rotational speed of the motor 20 based on the first through third rotation signals from the first through third rotational position sensors 28A through 28C.

When the drive command and the desired rotational speed are received from the operation controller 91, the motor drive controller 92 performs speed feedback control. Specifically, the motor drive controller 92 calculates a speed deviation. The speed deviation is a difference between the desired rotational speed and the actual rotational speed. The motor drive controller 92 then calculates the duty ratio required to remove the speed deviation (i.e., to make the actual rotational speed consistent to the desired rotational speed). The motor drive controller 92 then outputs a drive control signal to each of the two on-target switches to turn on the corresponding target switch. The two on-target switches are two switches selected from the first through sixth switches Q1 through Q6 based on the rotational position. At least one of the drive control signals to the two on-target switches is a pulse width modulation signal having the calculated duty ratio. Therefore, the higher the duty ratio, the greater the electric power supplied to the motor 20.

The display controller 85 displays the rotational speed range input from the operation mode setter 87 on the first display screen 74. The display controller 85 displays the actual reciprocating count input from the reciprocating count calculator 79 on the set count display screen 75. The display controller 85 executes a notification process when occurrence of air entrapment is notified. The notification process notifies the user that air entrapment has occurred. The notification process may be performed in any manner. The notification process may be performed to enable visual and/or auditory recognition that air entrapment has occurred. In the first embodiment, the display controller 85 notifies the user of air entrapment by flashing the second display screen 75A and the third display screen 75B. Alternatively, the display controller 85 may notify the user of air entrapment by displaying a preset numerical value, symbol, character, etc., on the second display screen 75A and the third display screen 75B. The display controller 85 is one example of the notifier in Overview of Embodiments.

### 2-1-6. Main Process

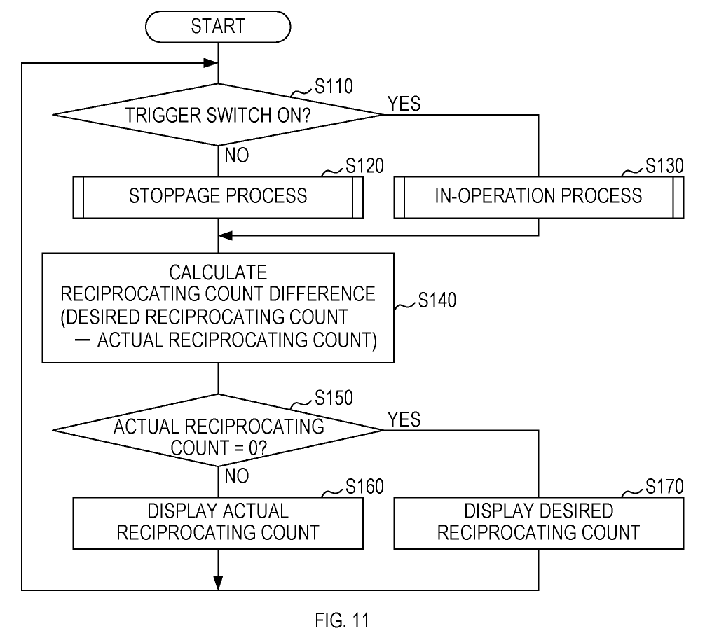

Referring to FIG. 11, the main process for achieving various functions in the automatic dispensing mode is described. When the operation mode is set to the automatic dispensing mode, the control circuit 80 (more specifically, the CPU 80A) executes the main process shown in FIG. 11.

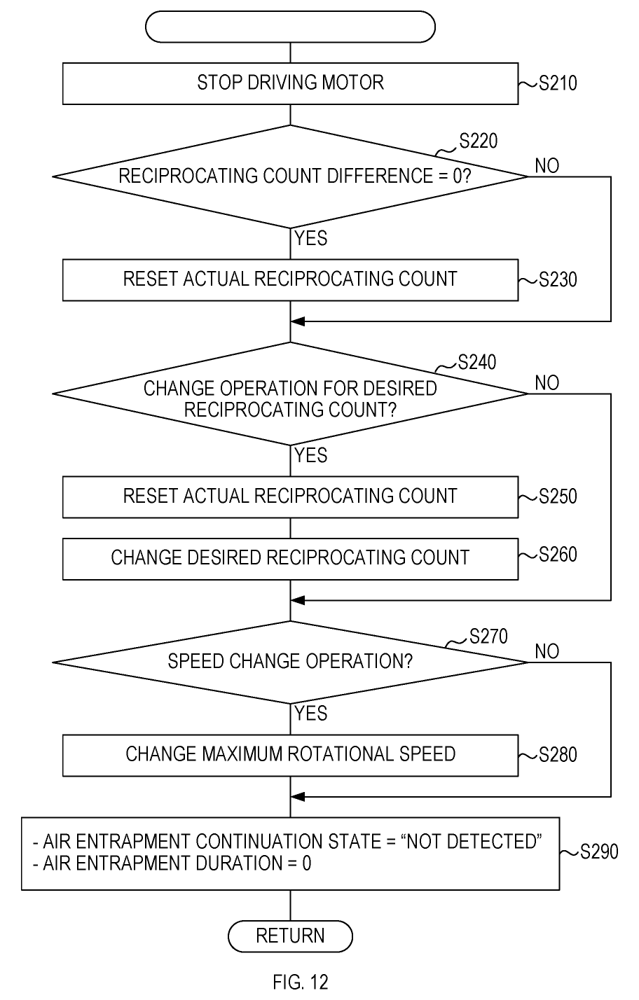

The control circuit 80, when starting the main process, determines in S110 whether the trigger switch 8 is on. If the trigger switch 8 is off, the process proceeds to S120. In S120, the control circuit 80 executes a stoppage process. Details of the stoppage process are shown in FIG. 12.

The control circuit 80, when proceeding to the stoppage process, stops driving the motor 20 in S210. Specifically, the operation controller 91 stops outputting the drive command. In S220, the control circuit 80 determines whether the current reciprocating count difference is zero. If the reciprocating count difference is not zero, the process proceeds to S240. In this case, the current reciprocating count difference is maintained. If the reciprocating count difference is zero, the process proceeds to S230. For example, when the plunger 50 has completed the desired number of reciprocations, causing the motor 20 to automatically stop, and the trigger 9 is turned off by the user based on the automatic stopping of the motor 20, the reciprocating count difference may be determined as zero in S220. In S230, the control circuit 80 resets the actual reciprocating count to an initial value (e.g., zero).

In S240, the control circuit 80 determines whether a change operation for the desired reciprocating count has been performed. The change operation includes the second switch 72 or the third switch 73 being turned on. If no change operation has been performed, the process proceeds to S270. If a change operation has been performed, the process proceeds to S250.

In S250, the control circuit 80 resets the actual reciprocating count to its initial value. In S260, the control circuit 80 changes the desired reciprocating count in accordance with the change operation.

In S270, the control circuit 80 determines whether a speed change operation has been performed. The speed change operation includes the first switch 71 being turned on. If no speed change operation has been performed, the process proceeds to S290. If the speed change operation has been performed, the process proceeds to S280. In S280, the control circuit 80 changes the rotational speed range (i.e., changes the maximum rotational speed) in response to the speed change operation.

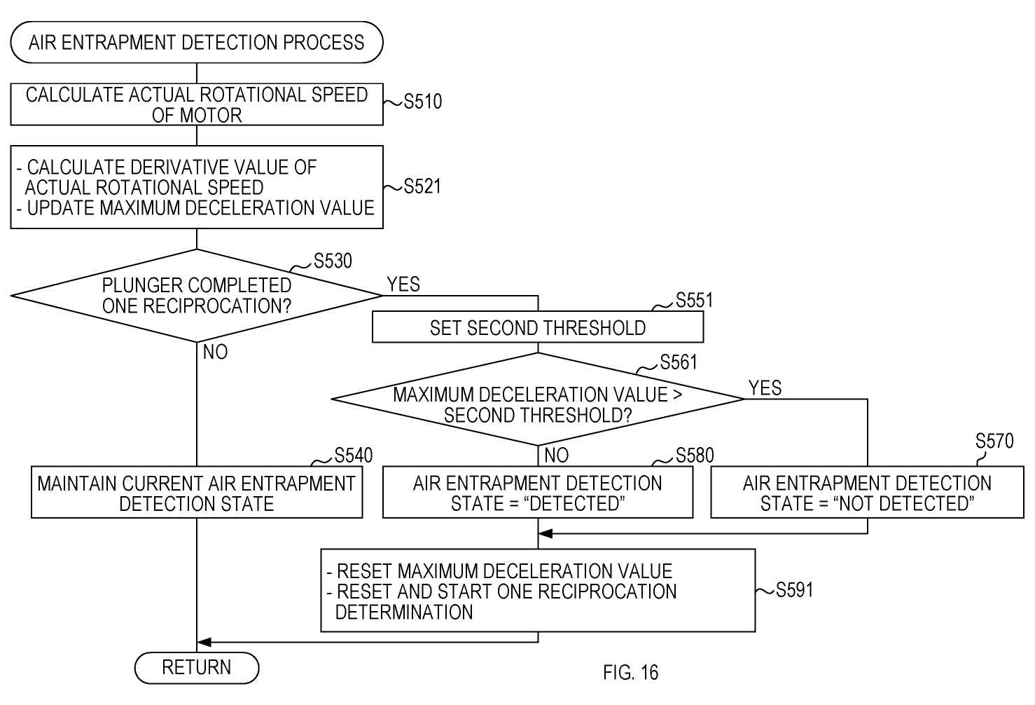

In S290, the control circuit 80 sets the air entrapment continuation state to “Not Detected”. The control circuit 80 further sets the air entrapment duration to zero (that is, resets the air entrapment duration). After S290, the process proceeds to S140 (FIG. 16).

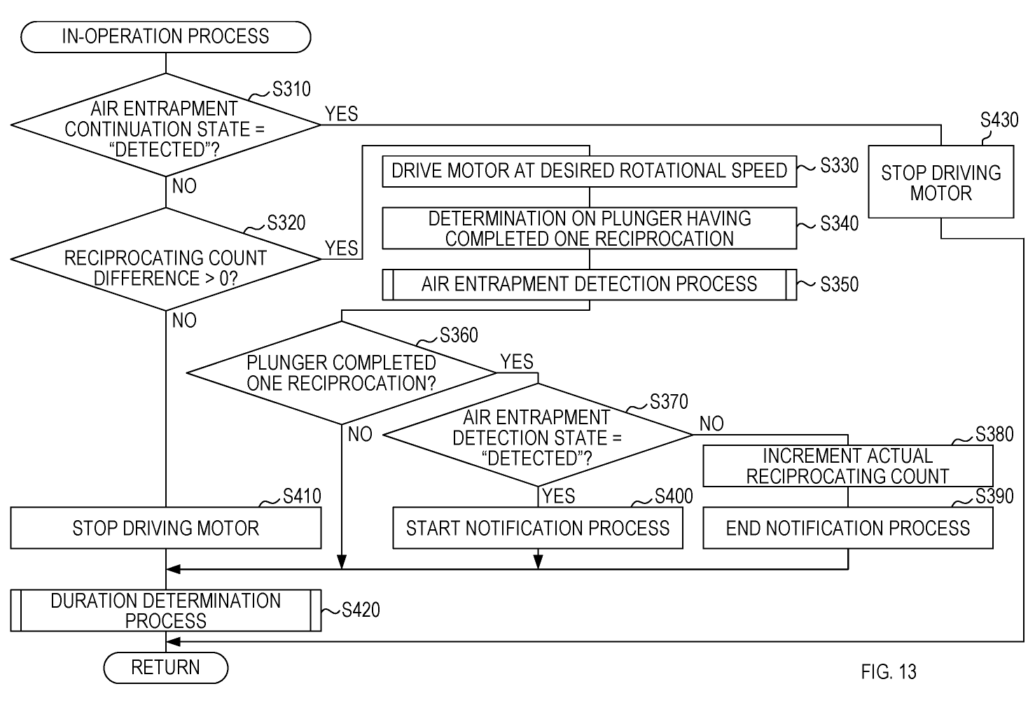

If the trigger switch 8 is on in S110, the process proceeds to S130. In S130, the control circuit 80 executes an in-operation process. Details of the in-operation process are shown in FIG. 13.

The control circuit 80, when proceeding to the in-operation process, determines in S310 whether the air entrapment continuation state is set to “Detected”. If the air entrapment continuation state is not set to “Detected”, the process proceeds to S320. In S320, the control circuit 80 determines whether the current reciprocating count difference is greater than zero. If the reciprocating count difference is zero, the control circuit 80 stops driving the motor 20 in S410, as in S210. The reciprocating count difference being zero corresponds to the dispensing operation having been executed the desired number of reciprocations. After S410, the process proceeds to S420.

In S320, if the reciprocating count difference is greater than zero, the process proceeds to S330. The reciprocating count difference being greater than zero corresponds to the actual reciprocating count not yet reaching the desired reciprocating count. In S330, the control circuit 80 drives the motor 20 at the desired rotational speed corresponding to the current rotational speed range. That is, the control circuit 80 executes the aforementioned speed feedback control.

In S340, the control circuit 80 determines whether the plunger 50 has completed one reciprocation.

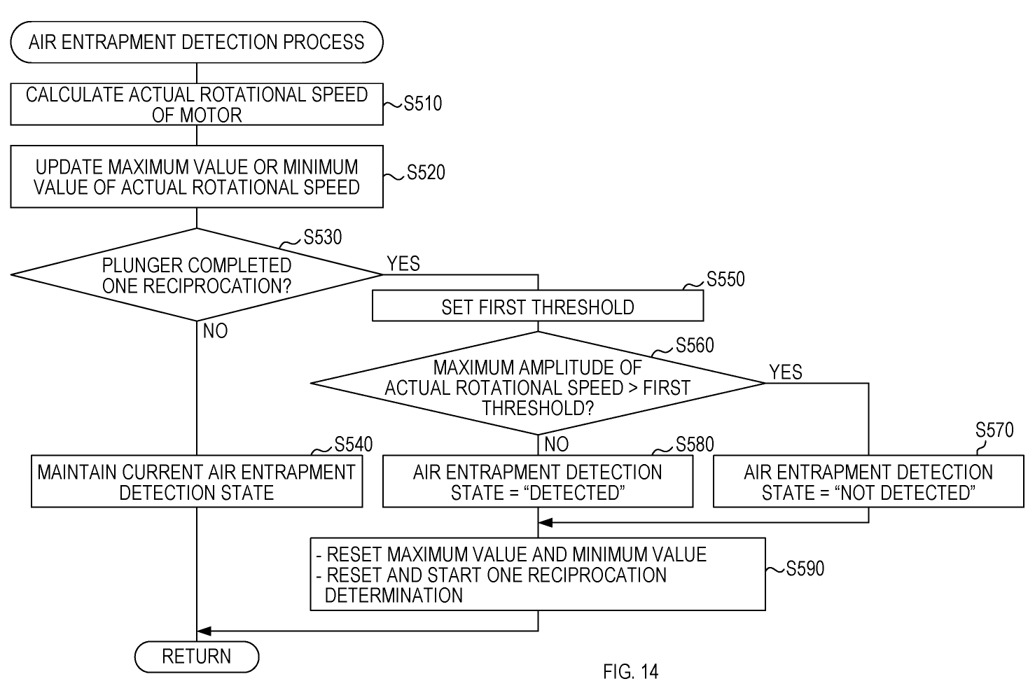

In S350, the control circuit 80 executes an air entrapment detection process. The air entrapment detection process is a process to detect whether air entrapment has occurred. Details of the air entrapment detection process are shown in FIG. 14.

The control circuit 80, when proceeding to the air entrapment detection process, calculates the actual rotational speed of the motor 20 in S510.

In S520, the control circuit 80 updates the maximum or minimum value of the actual rotational speed. The maximum and minimum values of the actual rotational speed are (i) reset each time the plunger 50 completes one reciprocation, and (ii) may be updated each time S520 is executed after reset.

For example, if the latest actual rotational speed calculated in S510 is greater than the currently held maximum value, the maximum value of the actual rotational speed is updated to the latest actual rotational speed. Similarly, if the latest actual rotational speed is less than the currently held minimum value, the minimum value of the actual rotational speed is updated to the latest actual rotational speed. Furthermore, if the latest actual rotational speed is greater than or equal to the currently held minimum value and less than or equal to the currently held maximum value, the current maximum and minimum values are maintained.

In S530, the control circuit 80 determines whether the plunger 50 has completed one reciprocation based on the result of determination in S340. If the plunger 50 has not yet completed one reciprocation, the process proceeds to S540. In S540, the control circuit 80 maintains the current air entrapment detection state (“Detected” or “Not Detected”). After S540, the process proceeds to S360 (FIG. 13).

In S530, when the plunger 50 completes one reciprocation, the process proceeds to S550. In S550, the control circuit 80 sets the first threshold. Specifically, as described above, the control circuit 80 sets the first threshold based on the desired rotational speed, the duty ratio, the actual rotational speed, or the device temperature.

In S560, the control circuit 80 determines whether a maximum amplitude of the actual rotational speed is greater than the first threshold. The maximum amplitude is a difference between the maximum value and the minimum value of the currently held actual rotational speed. For each reciprocation of the plunger 50, the maximum value and minimum value of the actual rotational speed during that reciprocation are obtained in S520. The difference between the maximum value and minimum value is the maximum amplitude.

If the maximum amplitude is greater than the first threshold, the process proceeds to S570. In this case, the control circuit 80 determines that no air entrapment has occurred. Therefore, in S570, the control circuit 80 sets the air entrapment detection state to “Not Detected”. After S570, the process proceeds to S590.

If the maximum amplitude is smaller than or equal to the first threshold, the process proceeds to S580. In this case, the control circuit 80 determines that air entrapment has occurred. Therefore, in S580, the control circuit 80 sets the air entrapment detection state to “Detected”. After S580, the process proceeds to S590.

In S590, the control circuit 80 resets the currently held maximum value and minimum value of the actual rotational speed. The control circuit 80 further resets the result of determination in S340 that the plunger 50 has completed one reciprocation, thereby restarting the determination of whether the plunger 50 has completed one reciprocation. Therefore, when the plunger 50 completes another reciprocation starting from this restart timing, it is determined again in S340 that the plunger 50 has completed one reciprocation. After S590, the process proceeds to S360 (FIG. 13).

In S360, the control circuit 80 determines whether the plunger 50 has completed one reciprocation based on the result of determination in S340. If the plunger 50 has not completed one reciprocation, the process proceeds to S420. If the plunger 50 has completed one reciprocation, the process proceeds to S370.

In S370, the control circuit 80 determines whether the air entrapment detection state is set to “Detected”. If the air entrapment detection state is set to “Detected”, meaning that air entrapment has occurred, the process proceeds to S400. In S400, the control circuit 80 initiates the aforementioned notification process. That is, the control circuit 80 notifies the user that air entrapment has occurred. After S400, the process proceeds to S420.

In S370, if the air entrapment detection state is not set to “Detected,” meaning that no air entrapment has occurred, the process proceeds to S380. In S380, the control circuit 80 increments the actual reciprocating count. That is, the control circuit 80 updates the actual reciprocating count with the current count plus “1”. In S390, if the notification process is being executed, the control circuit 80 terminates the notification process. After S390, the process proceeds to S420.

If the air entrapment detection state is set to “Detected” in S370, the actual reciprocating count is not incremented, and the current actual reciprocating count is maintained. That is, while air entrapment is detected, even if the plunger 50 completes one reciprocation, the actual reciprocating count is not changed.

If the air entrapment continuation state is set to “Detected” in S310, the process proceeds to S430. In S430, the control circuit 80 stops driving the motor 20, as in S210. After S430, the process proceeds to S140 (FIG. 11).

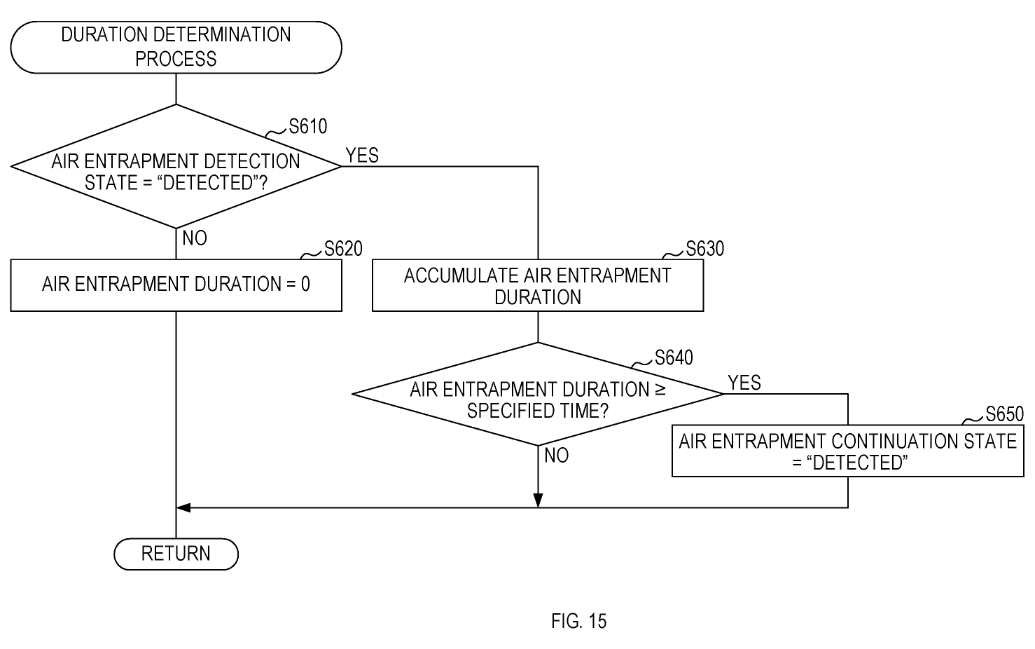

In S420, the control circuit 80 executes a duration determination process. Details of the duration determination process are shown in FIG. 15. Upon proceeding to the duration determination process, the control circuit 80 determines in S610 whether the air entrapment detection state is set to “Detected”. If the air entrapment detection state is not set to “Detected”, meaning no air entrapment has occurred, the process proceeds to S620.

In S620, the control circuit 80 resets the air entrapment duration to zero. After S620, the process proceeds to S140 (FIG. 11).

If the air entrapment detection state is set to “Detected” in S610, meaning that air entrapment has occurred, the process proceeds to S630. In S630, the control circuit 80 accumulates the air entrapment duration. That is, the control circuit 80 increments (accumulates) the aforementioned count value used for measurement by one.

In S640, the control circuit 80 determines whether the air entrapment duration is longer than or equal to a specified time (i.e., whether the count value is greater than or equal to a specified value). If the air entrapment duration is less than the specified time, the process proceeds to S140 (FIG. 11). If the air entrapment duration is equal to or longer than the specified time, the process proceeds to S650.

In S650, the control circuit 80 sets the air entrapment continuation state to “Detected”. That is, it is determined that air entrapment has been continuing for a specified time or longer. After S650, the process proceeds to S140 (FIG. 11).

In S140, the control circuit 80 calculates (i.e., updates) the reciprocating count difference. Specifically, the control circuit 80 subtracts the current actual reciprocating count from the current desired reciprocating count and updates the reciprocating count difference with the resulting difference.

In S150, the control circuit 80 determines whether the current actual reciprocating count is zero. If the actual reciprocating count is not zero, the process proceeds to S160. In this case, the plunger 50 has already moved at least one reciprocating distance in the automatic dispensing mode. Therefore, in S160, the control circuit 80 displays the current actual reciprocating count on the set count display screen 75. This allows the user to confirm how far the dispensing of grease has progressed. After S160, the process proceeds to S110.

If the actual reciprocating count is zero in S150, the process proceeds to S170. In this case, it is possible that, for example, the trigger 9 has not yet been manually operated, or that the trigger 9 was manually operated but the actual reciprocating count has not yet reached one reciprocation. Therefore, in S170, the control circuit 80 displays the desired reciprocating count on the set count display screen 75. This allows the user to confirm the desired reciprocating count. After S170, the process proceeds to S110.

Here, correspondence between the processes in FIGS. 11 through 15 and FIG. 6 is briefly explained. S110, S310, and S320 correspond to processing by the operation controller 91. S210, S330, S410, and S430 correspond to processing by the operation controller 91 and the motor drive controller 92. S140, S220, S230, S250, and S380 correspond to processing by the reciprocating count calculator 79. S240 and S260 correspond to processing by the reciprocating count setter 83. S270 and S280 correspond to processing by the operation mode setter 87. S290 and S420 correspond to processing by the time counter 88. S340 and S360 correspond to processing by the reciprocation determiner 89. S350 corresponds to processing by the air entrapment detector 90. S370 corresponds to processing by the reciprocating count calculator 79 and the display controller 85. S150 through S170, S390, and S400 correspond to processing by the display controller 85.

### 2-2. Second Embodiment

Another example of the air entrapment detection process is described as the second embodiment. The electric-powered lubricant dispenser of the second embodiment is configured essentially the same as the electric-powered lubricant dispenser 1 of the first embodiment, except for the air entrapment detection process. Hereinafter, the configuration differing from that of the first embodiment is described.

In the second embodiment, the air entrapment detector 90 detects occurrence of air entrapment based on the derivative value of the actual rotational speed. The derivative value may be calculated in any manner. For example, the derivative value may be calculated based on time derivative. That is, an amount of change in the actual rotational speed per specified unit time may be calculated as the derivative value. Alternatively, the derivative value may be calculated based on rotational angle derivative. That is, the amount of change in the actual rotational speed during the time the motor 20 (more specifically, the rotor 22) rotates by a specified unit rotational angle may be calculated as the derivative value.

In the air entrapment state, fluctuation in the actual rotational speed is relatively small. Small fluctuation in the actual rotational speed corresponds to a small absolute value of the derivative value. Therefore, air entrapment can be detected based on the absolute value (its maximum value) of the derivative value within a specified drive period. For example, air entrapment may be determined to have occurred when the maximum absolute value of the derivative value is less than or equal to the second threshold.

However, the difference in the plunger load due to presence or absence of air entrapment is particularly pronounced during the descent of the plunger 50 (i.e., during the dispensing operation).

When no gas is trapped during the descent of the plunger 50, the plunger 50 experiences a relatively large load, which can significantly reduce the actual rotational speed. That is, substantial deceleration can occur.

On the other hand, if gas is present during the descent of the plunger 50, the plunger load becomes relatively small, so the decrease in the actual rotational speed is also relatively small. That is, the deceleration is relatively small.

Therefore, in the second embodiment, air entrapment is detected by focusing specifically on the deceleration (i.e., the absolute value of the derivative value of the actual rotational speed during the descent of the plunger). Specifically, air entrapment is determined to have occurred when the maximum deceleration value is less than or equal to the second threshold. That is, the aforementioned specified requirement in the second embodiment includes the maximum deceleration value within the specified drive period being less than or equal to the second threshold.

The second threshold may be set to a value smaller than a third expected range and larger than a fourth expected range. The third expected range is a range of the deceleration expected in the normal state. The fourth expected range is a range of the deceleration expected in the air entrapped state.

The second threshold may be a fixed value. In the second embodiment, the second threshold is variably set in accordance with the operating state of the electric-powered lubricant dispenser 1, similar to the first threshold in the first embodiment.

Specifically, the second threshold may be set in accordance with the desired rotational speed. More specifically, the second threshold may be set in accordance with the desired rotational speed in the same manner as the first threshold. That is, in the low-speed range to medium-speed range, the second threshold may be set to increase as the desired rotational speed increases. In the high-speed range, the second threshold may be set to decrease as the desired rotational speed increases. For example, a vertical axis in FIG. 10 may be interpreted as the second threshold.

For example, the second threshold may be set in accordance with various operating states, such as the actual rotational speed, duty ratio, or device temperature, similar to the first threshold. Specifically, the second threshold may be set in accordance with the actual rotational speed in the same manner as setting the first threshold in accordance with the desired rotational speed. For example, a horizontal axis in FIG, 10 may be interpreted as the actual rotational speed and the vertical axis as the second threshold. Furthermore, the second threshold may be set in accordance with the duty ratio in the same manner as setting the first threshold in accordance with the duty ratio. For example, the horizontal axis in FIG. 10 may be interpreted as the duty ratio and the vertical axis as the second threshold. Furthermore, the second threshold may be set based on the device temperature in the same manner as setting the first threshold based on the device temperature. Specifically, the second threshold may be set to decrease as the grease temperature increases.

To achieve such air entrapment detection, in the second embodiment, in S350 in FIG. 13, the air entrapment detection process shown in FIG. 16 is executed instead of the air entrapment detection process shown in FIG. 14.

The air entrapment detection process in FIG. 16 differs from the air entrapment detection process in FIG. 14 in that (i) S521 is executed instead of S520, (ii) S551 is executed instead of S550, (iii) S561 is executed instead of S560, and (iv) S591 is executed instead of S590.

In S521, the control circuit 80 calculates the derivative value of the actual rotational speed calculated in S510. The control circuit 80 further updates the maximum deceleration value based on the calculated derivative value. The maximum deceleration value is (i) reset each time the plunger 50 completes one reciprocation, and (ii) may be updated each time S521 is executed after reset. For example, if the latest derivative value calculated in S521 is negative and the absolute value of the derivative value (i.e., the deceleration) is greater than the currently held maximum deceleration value, the maximum deceleration value is updated to the latest deceleration value.

In S551, the control circuit 80 sets the second threshold. Specifically, the control circuit 80 sets the second threshold based on the desired rotational speed, the duty ratio, the actual rotational speed, or the device temperature, as described above.

In S561, the control circuit 80 determines whether the currently held maximum deceleration value is greater than the second threshold. If the maximum deceleration value is greater than the second threshold, the process proceeds to S570. In this case, the control circuit 80 determines that air entrapment has not occurred. If the maximum deceleration value is less than or equal to the second threshold, the process proceeds to S580. In this case, the control circuit 80 determines that air entrapment has occurred.

In S591, the control circuit 80 resets the currently held maximum deceleration value. Furthermore, as in S590 in the first embodiment, the control circuit 80 resets the result of determination in S340 that the plunger 50 has completed one reciprocation and restarts the determination of whether the plunger 50 has completed one reciprocation.

### 2-3. Third Embodiment

A further another example of the air entrapment detection process is described as the third embodiment. The electric-powered lubricant dispenser of the third embodiment is configured essentially the same as the electric-powered lubricant dispenser 1 of the first embodiment, except for the air entrapment detection process. The configuration differing from the first embodiment is described below.

In the third embodiment, the air entrapment detector 90 detects the occurrence of air entrapment based on the actual rotational speed itself. As mentioned earlier, for the same desired rotational speed, the actual rotational speed in the normal state can be lower than the actual rotational speed in the air entrapped state. Therefore, in the third embodiment, air entrapment is determined to have occurred when the minimum actual rotational speed within a specified drive period is greater than or equal to the third threshold. That is, the aforementioned specified requirement in the third embodiment includes the minimum actual rotational speed within the specified drive period being greater than or equal to the third threshold.

The third threshold may be a fixed value, but in the third embodiment, the third threshold is changed in accordance with the operating state of the electric-powered lubricant dispenser 1, similar to the first and second thresholds.

Specifically, the third threshold may be set in accordance with the desired rotational speed. More specifically, the third threshold may be set to a value less than the desired rotational speed. For example, each time the desired rotational speed changes, the third threshold may be set based on a specified calculation using the changed desired rotational speed. The specified calculation may include, for example, setting the third threshold to a speed that is a specified speed or specified percentage lower than the desired rotational speed. The specified speed and the specified percentage may be changed in accordance with the desired rotational speed. The third threshold may be variably set based on the actual rotational speed or the duty ratio. Specifically, the third threshold may be (i) fundamentally set based on the desired rotational speed and (ii) adjusted (i.e., changed) based on the actual rotational speed or the duty ratio.

The third threshold may be varied in accordance with the device temperature. For example, the third threshold may be (i) basically set in accordance with the desired rotational speed, and (ii) set to increase as the device temperature rises.

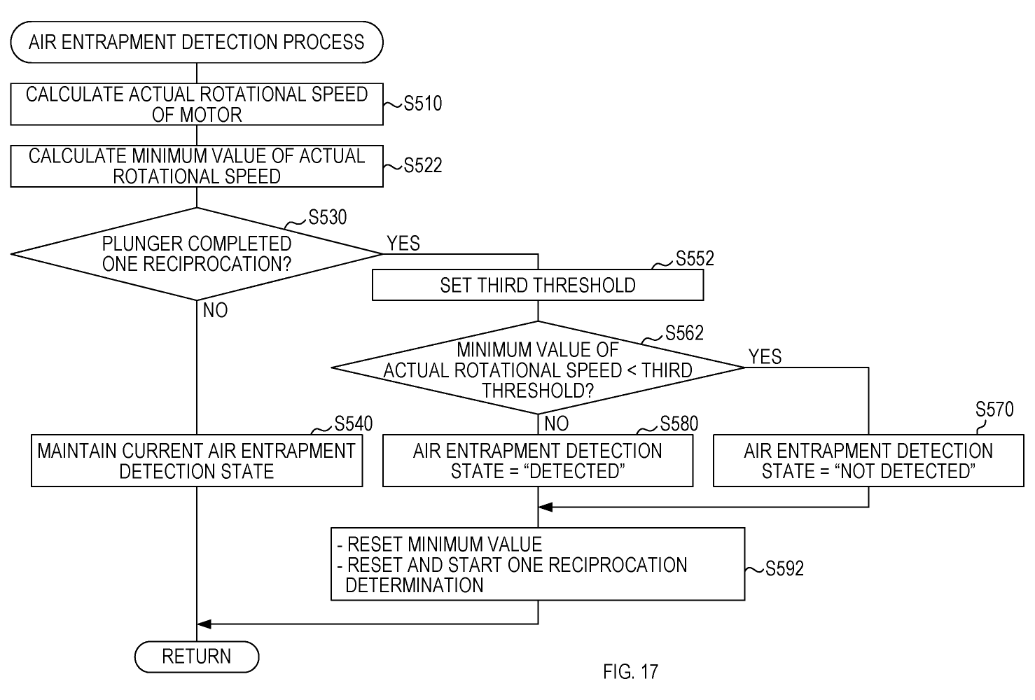

To achieve such air entrapment detection, in the third embodiment, in S350 in FIG. 13, the air entrapment detection process shown in FIG. 17 is executed instead of the air entrapment detection process in FIG. 14.

The air entrapment detection process in FIG. 17 differs from the air entrapment detection process in FIG. 14 in that (i) S522 is executed instead of S520, (ii) S552 is executed instead of S550, (iii) S562 is executed instead of S560, and (iv) S592 is executed instead of S590.

In S522, the control circuit 80 updates the minimum actual rotational speed based on the actual rotational speed calculated in S510. The minimum actual rotational speed is (i) reset each time the plunger 50 completes one reciprocation, and (ii) can be updated each time S522 is executed after reset. For example, if the latest actual rotational speed calculated in S510 is less than the currently held minimum value, the minimum actual rotational speed is updated to the latest actual rotational speed.

In S552, the control circuit 80 sets the third threshold. Specifically, the control circuit 80 sets the third threshold based on various operating conditions, such as the desired rotational speed or the device temperature, as described above.

In S562, the control circuit 80 determines whether the currently held minimum actual rotational speed is less than the third threshold. If the minimum actual rotational speed is less than the third threshold, the process proceeds to S570. In this case, the control circuit 80 determines that air entrapment has not occurred. If the minimum actual rotational speed is greater than or equal to the third threshold, the process proceeds to S580. In this case, the control circuit 80 determines that air entrapment has occurred.

In S592, the control circuit 80 resets the currently held minimum value of the actual rotational speed. Furthermore, as in S590 in the first embodiment, the control circuit 80 resets the result of determination in S340 that the plunger 50 has completed one reciprocation and restarts the determination of whether the plunger 50 has completed one reciprocation.

### 2-4. Other Embodiments

The above describes embodiments of the present disclosure. However, the present disclosure is not limited to the embodiments described above and may be implemented in various modifications.

2-4-1. In the above embodiments, air entrapment is detected based on the amplitude of the actual rotational speed, the derivative value of the actual rotational speed, or the actual rotational speed itself. However, air entrapment may be detected based on an actual amount of any operation. The actual operating amount may be any amount (e.g., physical quantity) indicating the actual rotational speed or the magnitude of fluctuation in the actual rotational speed.

2-4-2. The first threshold may be set based on an operating state different from the operating states (desired rotational speed, duty ratio, actual rotational speed, or device temperature) exemplified in the above embodiments. The first threshold may be set based on any operating state of the electric-powered lubricant dispenser 1. The first threshold may be set based on a load-related operating state. The load-related operating state is an operating state that affects the actual rotational speed. That is, the actual rotational speed may change in response to changes in the load-related operating state.

For example, the operating state may be a battery voltage. That is, the first threshold may be set in accordance with the magnitude of the battery voltage. Even if the duty ratio remains constant, a decrease in the battery voltage reduces the electric power supplied to the motor 20, thereby decreasing the actual rotational speed. Therefore, the first threshold may be set to decrease as the battery voltage decreases. To achieve this, the electric-powered lubricant dispenser 1 may include a voltage detector that detects the battery voltage. The voltage detector may be configured (i) to receive the battery voltage and (ii) to output a voltage detection signal corresponding to the magnitude of the battery voltage to the control circuit 80. The control circuit 80 may (i) acquire the magnitude of the battery voltage based on the voltage detection signal from the voltage detector and (ii) set the first threshold based on the acquired magnitude.

The second and third thresholds may also be variably set based on other various operating states in the same manner.

2-4-3. In the first embodiment, the first threshold may be set based on an average value of a numerical value indicating the operating state (hereinafter referred to as the “state quantity”). The average value is, in other words, a smoothed value. Examples of the state quantity include the desired rotational speed, the duty ratio, the actual rotational speed, or the device temperature. The average value of the state quantity may be calculated by any method. For example, an interval average or a moving average of the state quantity may be calculated. In this case, the first threshold may be set in accordance with the calculated interval average or moving average. A calculation target interval for the interval average and moving average may be determined in any manner. The calculation target interval may, for example, be the specified drive period mentioned earlier (i.e., the period during which the plunger 50 completes one reciprocation).

Alternatively, a low-pass filter may be provided to which the state quantity is input. The low-pass filter removes components with frequencies more than or equal to a specified frequency from the state quantity input in time series and outputs the state quantity with those components removed. The first threshold may be set based on the output value of the low-pass filter. The low-pass filter may be implemented by the CPU 80A executing a program for the low-pass filter.

The second threshold in the second embodiment and the third threshold in the third embodiment may also be set based on the averaged state quantity, similar to the first threshold.

2-4-4. In the above embodiments, the notification process and temporary suspension of the accumulation of the actual reciprocating count are exemplified as specified processes executed when air entrapment is detected. However, when air entrapment is detected, other specified processes may be executed in addition to or instead of these processes.

2-4-5. In the above embodiments, the reciprocation determiner 89 determines one reciprocation of the plunger 50 based on the first to third rotation signals. However, any method may be used to determine one reciprocation of the plunger 50. For example, a sensor that can detect rotation of the crank plate 46 may be provided near the crank plate 46. One reciprocation of the plunger 50 may be determined based on the detection result from that sensor. Furthermore, for example, a sensor that detects the position of the plunger 50 or the slider 48 may be provided near the plunger 50 or the slider 48. The detection result from that sensor may be used to determine one reciprocation of the plunger 50.

2-4-6. Techniques disclosed herein are applicable to any reciprocating pump. For example, the disclosure is also applicable to a diaphragm pump. Furthermore, it is not limited to a reciprocating pump but is applicable to any types of pump that can dispense lubricant.

2-4-7. The electric-powered lubricant dispenser 1 may be configured to dispense a lubricant other than grease. Such lubricant may be, for example, semi-solid or liquid (for example, lubricating oil or grease).

2-4-8. The rotational speed range, the operation mode, and the desired reciprocating count may be set by methods different from those of the above embodiments. For example, a user interface (e.g., buttons, dials, levers, touch panels, etc.) that is different in form from the second and third switches 72, 73 for setting the operation mode may be provided. The operation mode may then be switched in response to operation of the user interface. The same applies to the desired reciprocating count. The rotational speed range may also be switched in accordance with operation of a user interface (e.g., buttons, dials, levers, touch panels, etc.) in the form different from the first switch 71.

2-4-9. In the above embodiments, the rotational state of the motor 20 (i.e., rotational position and actual rotational speed) is acquired using the first through third rotational position sensors 28A through 28C. However, the rotational state may be acquired by other methods. For example, so-called sensorless control may be employed in the electric-powered lubricant dispenser 1. That is, the rotational state of the motor 20 may be acquired based on the induced voltage generated in each of the three coils 24 of the motor.

### 2-5. Supplementary Notes

Multiple functions achieved by a single component in the above embodiments may be achieved by multiple components, and a single function achieved by a single component may be achieved by multiple components. Furthermore, multiple functions achieved by multiple components may be achieved by a single component, and a single function achieved by multiple components may be achieved by a single component. Also, some components of the above embodiments may be omitted. Additionally, at least part of the configuration of one embodiment may be added to or substituted for the configuration of another embodiment.

What is claimed is:

1. An electric-powered lubricant dispenser comprising:
a motor;
a pump configured to be driven by the motor and dispense a lubricant;
a drive circuit configured to drive the motor; and
a control circuit configured:
to rotate the motor via the drive circuit, and
to perform a specified process based on (i) the motor being driven and (ii) an actual operating amount of the motor satisfying a specified requirement, the actual operating amount indicating an actual rotational speed of the motor or a magnitude of fluctuation in the actual rotational speed, the specified requirement being a condition indicating that gas is present in the pump.

2. The electric-powered lubricant dispenser according to claim 1,
wherein the actual operating amount includes an amplitude of the actual rotational speed, and
wherein the specified requirement includes a maximum value of the amplitude within a specified drive period being less than or equal to a first threshold.

3. The electric-powered lubricant dispenser according to claim 1,
wherein the actual operating amount includes an absolute value of a derivative value of the actual rotational speed, and
wherein the specified requirement includes a maximum value of the absolute value within a specified drive period being less than or equal to a second threshold.

4. The electric-powered lubricant dispenser according to claim 1,
wherein the actual operating amount includes the actual rotational speed, and
wherein the specified requirement includes a minimum value of the actual rotational speed within a specified drive period being greater than or equal to a third threshold.

5. The electric-powered lubricant dispenser according to claim 2,
wherein the control circuit is configured to change the first threshold in accordance with an operating state of the electric-powered lubricant dispenser.

6. The electric-powered lubricant dispenser according to claim 3,
wherein the control circuit is configured to change the second threshold in accordance with an operating state of the electric-powered lubricant dispenser.

7. The electric-powered lubricant dispenser according to claim 4,
wherein the control circuit is configured to change the third threshold in accordance with an operating state of the electric-powered lubricant dispenser.

8. The electric-powered lubricant dispenser according to claim 5,
wherein the control circuit is configured (i) to set a desired rotational speed that is a desired value of a rotational speed of the motor, and (ii) to control the drive circuit so that the actual rotational speed is consistent with the desired rotational speed, and
wherein the operating state includes the desired rotational speed.

9. The electric-powered lubricant dispenser according to claim 5,
wherein the control circuit is configured to output a pulse width modulated signal having a duty ratio to the drive circuit to control the drive circuit,
wherein the drive circuit is configured (i) to receive the pulse width modulated signal, and (ii) to drive the motor in accordance with the duty ratio of the received pulse width modulated signal, and
wherein the operating state includes the duty ratio.

10. The electric-powered lubricant dispenser according to claim 5,
wherein the operating state includes the actual rotational speed.

11. The electric-powered lubricant dispenser according to claim 5,
wherein the control circuit is configured to acquire a temperature of the electric-powered lubricant dispenser, and
wherein the operating state includes the temperature.

12. The electric-powered lubricant dispenser according to claim 1, further comprising:
a notifier configured to notify a user of the electric-powered lubricant dispenser of information indicating that the gas is present in the pump,
wherein the specified process includes notifying the user of the information via the notifier.

13. The electric-powered lubricant dispenser according to claim 1,
wherein the pump is configured to repeat a specified dispensing operation for dispensing the lubricant,
wherein the control circuit is configured:
to accumulate an actual dispensing count each time the pump performs the specified dispensing operation during driving of the motor, the actual dispensing count representing a number of times the specified dispensing operation is performed; and
to stop the motor based on the actual dispensing count having reached a desired dispensing count, and
wherein the specified process includes temporarily stopping accumulation of the actual dispensing count.

14. The electric-powered lubricant dispenser according to claim 13,
wherein the control circuit is configured, after temporarily stopping the accumulation of the actual dispensing count, to resume the accumulation of the actual dispensing count based on the actual operating amount no longer satisfying the specified requirement.

15. The electric-powered lubricant dispenser according to claim 1,
wherein the pump includes:
a chamber configured to contain the lubricant;
a dispensing port communicating with the chamber; and
a plunger located in the chamber, the plunger being configured (i) to reciprocate within the chamber based on a rotational force of the motor and (ii) to thereby dispense the lubricant in the chamber from the dispensing port.

16. The electric-powered lubricant dispenser according to claim 2,
wherein the pump includes:
a chamber configured to contain the lubricant;
a dispensing port communicating with the chamber; and
a plunger located in the chamber, the plunger being configured (i) to reciprocate within the chamber based on a rotational force of the motor and (ii) to thereby dispense the lubricant in the chamber from the dispensing port,
wherein the specified drive period includes a period during which the plunger completes one reciprocation within the chamber.

17. The electric-powered lubricant dispenser according to claim 13,
wherein the pump includes:
a chamber configured to contain the lubricant;
a dispensing port communicating with the chamber; and
a plunger located in the chamber, the plunger being configured (i) to reciprocate within the chamber based on a rotational force of the motor and (ii) to thereby dispense the lubricant in the chamber from the dispensing port,
wherein the specified dispensing operation includes the plunger completing one reciprocation within the chamber.

18. The electric-powered lubricant dispenser according to claim 1,
wherein the control circuit is configured to stop the motor based on a state in which the actual operating amount satisfies the specified requirement having continued for a specified time during driving of the motor.

19. The electric-powered lubricant dispenser according to claim 1,
wherein the control circuit is configured to detect that the gas is present in the pump and/or the pump is about to dispense the gas, in response to the specified requirement being satisfied during driving of the motor.

20. A method for dispensing a lubricant from an electric-powered lubricant dispenser, the method comprising:
driving a pump of the electric-powered lubricant dispenser by a motor of the electric-powered lubricant dispenser, the pump being configured to dispense the lubricant; and
performing a specified process in the electric-powered lubricant dispenser based on an actual operating amount of the motor satisfying a specified requirement during driving of the motor, the actual operating amount of the motor indicating an actual rotational speed of the motor or a magnitude of fluctuation in the actual rotational speed, the specified requirement being a requirement indicating that gas is present in the pump.
